(19) United States
(12) Patent Application Publication
(10) Pub. No.: US 2025/0322550 A1
(43) Pub. Date: Oct. 16, 2025

(54) ENCODING METHOD, DECODING METHOD, ENCODING DEVICE, AND DECODING DEVICE

(71) Applicant: Panasonic Intellectual Property Corporation of America, Torrance, CA (US)

(72) Inventors: Takahiro NISHI, Nara (JP); Toshiyasu Sugio, Osaka (JP); Noritaka Iguchi, Osaka (JP); Chong Soon Lim, Singapore (SG); Zheng Wu, Singapore (SG); Han Boon Teo, Singapore (SG); Keng Liang Loi, Singapore (SG); Chung Dean Han, Johor Bahru (MY); Farman Dumanov, Singapore (SG); Praveen Kumar Yadav, Singapore (SG)

(21) Appl. No.: 19/252,839

(22) Filed: Jun. 27, 2025

Related U.S. Application Data
(63) Continuation of application No. PCT/JP2024/000117, filed on Jan. 9, 2024.
(60) Provisional application No. 63/438,355, filed on Jan. 11, 2023.
(60) Provisional application No. 63/465,042, filed on May 9, 2023.

(51) Int. Cl. G06T 9/00; H04N 19/70

(52) U.S. Cl. CPC G06T 9/001; H04N 19/70

(57) ABSTRACT

An encoding method includes: encoding, into a bitstream, first reference information for a first set of vertices in a first three-dimensional mesh frame and second reference information for a second set of vertices in the first three-dimensional mesh frame; encoding the first set of vertices into the bitstream; and encoding the second set of vertices into the bitstream, in which the first reference information indicates a first value when a third set of vertices in a second three-dimensional mesh frame temporally different from the first three-dimensional mesh frame is used for the encoding of the first set of vertices, and the second reference information indicates a second value when a fourth set of vertices in the first three-dimensional mesh frame is used for the encoding of the second set of vertices.

### CROSS REFERENCE TO RELATED APPLICATIONS

This is a continuation application of PCT International Application No. PCT/JP2024/000117 filed on Jan. 9, 2024, designating the United States of America, which is based on and claims priority of U.S. Provisional Patent Application No. 63/438,355 filed on Jan. 11, 2023 and U.S. Provisional Patent Application No. 63/465,042 filed on May 9, 2023. The entire disclosures of the above-identified applications, including the specifications, drawings and claims are incorporated herein by reference in their entirety.

### FIELD

The present disclosure relates to, for example, an encoding device.

### BACKGROUND

PTL 1 proposes a method and a device for encoding and decoding three-dimensional mesh data.

### CITATION LIST

### Patent Literature

PTL 1: Japanese Unexamined Patent Application Publication No. 2006-187015

### SUMMARY

### Technical Problem

There are demands for further improvement in processing of encoding three-dimensional data and the like. An object of the present disclosure is to improve processing of encoding three-dimensional data and the like.

### Solution to Problem

An encoding method according to one aspect of the present disclosure includes: encoding, into a bitstream, first reference information for a first set of vertices in a first three-dimensional mesh frame and second reference information for a second set of vertices in the first three-dimensional mesh frame; encoding the first set of vertices into the bitstream; and encoding the second set of vertices into the bitstream, in which the first reference information indicates a first value when a third set of vertices in a second three-dimensional mesh frame is used for the encoding of the first set of vertices, the second three-dimensional mesh frame being temporally different from the first three-dimensional mesh frame, and the second reference information indicates a second value when a fourth set of vertices in the first three-dimensional mesh frame is used for the encoding of the second set of vertices.

Noted that these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### Advantageous Effects

The present disclosure can contribute toward improving processing of encoding three-dimensional data and the like.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a conceptual diagram illustrating a three-dimensional mesh according to an embodiment.

FIG. 2 is a conceptual diagram illustrating basic elements of the three-dimensional mesh according to the embodiment.

FIG. 3 is a conceptual diagram illustrating mapping according to the embodiment.

FIG. 4 is a block diagram illustrating a configuration example of an encoding/decoding system according to the embodiment.

FIG. 5 is a block diagram illustrating a configuration example of an encoding device according to the embodiment.

FIG. 6 is a block diagram illustrating another configuration example of the encoding device according to the embodiment.

FIG. 7 is a block diagram illustrating a configuration example of a decoding device according to the embodiment.

FIG. 8 is a block diagram illustrating another configuration example of the decoding device according to the embodiment.

FIG. 9 is a conceptual diagram illustrating a configuration example of a bitstream according to the embodiment.

FIG. 10 is a conceptual diagram illustrating another configuration example of the bitstream according to the embodiment.

FIG. 11 is a conceptual diagram illustrating yet another configuration example of the bitstream according to the embodiment.

FIG. 12 is a block diagram illustrating a specific example of the encoding/decoding system according to the embodiment.

FIG. 13 is a conceptual diagram illustrating a configuration example of point cloud data according to the embodiment.

FIG. 14 is a conceptual diagram illustrating a data file example of the point cloud data according to the embodiment.

FIG. 15 is a conceptual diagram illustrating a configuration example of mesh data according to the embodiment.

FIG. 16 is a conceptual diagram illustrating a data file example of the mesh data according to the embodiment.

FIG. 17 is a conceptual diagram illustrating a type of three-dimensional data according to the embodiment.

FIG. 18 is a block diagram illustrating a configuration example of a three-dimensional data encoder according to the embodiment.

FIG. 19 is a block diagram illustrating a configuration example of a three-dimensional data decoder according to the embodiment.

FIG. 20 is a block diagram illustrating another configuration example of the three-dimensional data encoder according to the embodiment.

FIG. 21 is a block diagram illustrating another configuration example of the three-dimensional data decoder according to the embodiment.

FIG. 22 is a conceptual diagram illustrating a specific example of encoding processing according to the embodiment.

FIG. 23 is a conceptual diagram illustrating a specific example of decoding processing according to the embodiment.

FIG. 24 is a block diagram illustrating an implementation example of the encoding device according to the embodiment.

FIG. 25 is a block diagram illustrating an implementation example of the decoding device according to the embodiment.

FIG. 26 is a block diagram illustrating an architecture of an encoding/decoding system according to the embodiment.

FIG. 27 is a block diagram illustrating an example of an architecture of an encoding device according to the embodiment.

FIG. 28 is a block diagram illustrating another example of the architecture of the encoding device according to the embodiment.

FIG. 29 is a block diagram illustrating an example of an architecture of a decoding device according to the embodiment.

FIG. 30 is a block diagram illustrating another example of the architecture of the decoding device according to the embodiment.

FIG. 31 is a block diagram illustrating another example of the architecture of the decoding device according to the embodiment.

FIG. 32 is a conceptual diagram illustrating an example of subdivision according to the embodiment.

FIG. 33 is a block diagram illustrating another example of the architecture of the decoding device according to the embodiment.

FIG. 34 is a flowchart illustrating three-dimensional mesh encoding processing according to the embodiment.

FIG. 35 is a conceptual diagram illustrating an example of reference information according to the embodiment.

FIG. 36 is a conceptual diagram illustrating an example of a three-dimensional region according to the embodiment.

FIG. 37 is a conceptual diagram illustrating an example of a vertex set located inside a rectangular parallelepiped according to the embodiment.

FIG. 38 is a conceptual diagram illustrating a relationship between a first vertex set, a third vertex set, and the difference therebetween according to the embodiment.

FIG. 39 is a conceptual diagram illustrating a relationship between a second vertex set, a fourth vertex set, and the difference therebetween according to the embodiment.

FIG. 40 is a conceptual diagram illustrating an example in which a plurality of vertexes in a first three-dimensional mesh frame are reconstructed according to the embodiment.

FIG. 41 is a conceptual diagram illustrating an example of application of connection information according to the embodiment.

FIG. 42 is a block diagram illustrating a configuration example of the encoding device for switching between the intra-prediction and the inter-prediction on a vertex set basis according to the embodiment.

FIG. 43 is a block diagram illustrating another configuration example of the encoding device for switching between the intra-prediction and the inter-prediction on a vertex set basis according to the embodiment.

FIG. 44 is a flowchart illustrating three-dimensional mesh decoding processing according to the embodiment.

FIG. 45 is a block diagram illustrating a configuration example of the decoding device for switching between the intra-prediction and the inter-prediction on a vertex set basis according to the embodiment.

FIG. 46 is a block diagram illustrating another configuration example of the decoding device for switching between the intra-prediction and the inter-prediction on a vertex set basis according to the embodiment.

FIG. 47 is a conceptual diagram illustrating a first example of a method of specifying a vertex set for the inter-prediction according to the embodiment.

FIG. 48 is a syntax diagram illustrating a syntax structure that corresponds to the first example of the method of specifying a vertex set for the inter-prediction according to the embodiment.

FIG. 49 is a conceptual diagram illustrating a second example of the method of specifying a vertex set for the inter-prediction according to the embodiment.

FIG. 50 is a syntax diagram illustrating a syntax structure that corresponds to the second example of the method of specifying a vertex set for the inter-prediction according to the embodiment.

FIG. 51 is a syntax diagram illustrating a variation of the syntax structure that corresponds to the second example of the method of specifying a vertex set for the inter-prediction according to the embodiment.

FIG. 52 is a conceptual diagram illustrating a third example of the method of specifying a vertex set for the inter-prediction according to the embodiment.

FIG. 53 is a syntax diagram illustrating a syntax structure that corresponds to the third example of the method of specifying a vertex set for the inter-prediction according to the embodiment.

FIG. 54 is a conceptual diagram two-dimensionally illustrating a vertex set specified in the third example of the method of specifying a vertex set for the inter-prediction according to the embodiment.

FIG. 55 is a conceptual diagram illustrating a fourth example of the method of specifying a vertex set for the inter-prediction according to the embodiment.

FIG. 56 is a syntax diagram illustrating a syntax structure that corresponds to the fourth example of the method of specifying a vertex set for the inter-prediction according to the embodiment.

FIG. 57 is a conceptual diagram two-dimensionally illustrating a vertex set specified in the fourth example of the method of specifying a vertex set for the inter-prediction according to the embodiment.

FIG. 58 is a conceptual diagram illustrating a fifth example of the method of specifying a vertex set for the inter-prediction according to the embodiment.

FIG. 59 is a syntax diagram illustrating a syntax structure that corresponds to the fifth example of the method of specifying a vertex set for the inter-prediction according to the embodiment.

FIG. 60 is a flowchart illustrating an example of basic encoding processing according to the embodiment.

FIG. 61 is a flowchart illustrating basic decoding processing according to the embodiment.

FIG. 62 is a block diagram illustrating another configuration example of the encoding device according to the embodiment.

FIG. 63 is a block diagram illustrating another configuration example of the decoding device according to the embodiment.

### DESCRIPTION OF EMBODIMENT

### Introduction

For example, a three-dimensional mesh is used for a computer graphics video. For example, the computer graphics video is formed by a plurality of frames that are temporally different from each other, and each frame may be represented by a three-dimensional mesh. A frame represented by a three-dimensional mesh is referred to also as a three-dimensional mesh frame.

In addition, the three-dimensional mesh is formed by vertex information that indicates a position of each of a plurality of vertexes in a three-dimensional space, connection information that indicates a connection relationship between the plurality of vertexes, and attribute information that indicates an attribute of each vertex or each face. Each face is constructed according to a connection relationship between a plurality of vertexes. Such a three-dimensional mesh can represent various computer graphics videos. Here, vertex may mean vertex information of a vertex. Furthermore, vertex set means a set of one or more vertexes and may mean vertex information of one or more vertexes.

Furthermore, for transmission and storage of a three-dimensional mesh, efficient encoding and decoding of a three-dimensional mesh is expected. For example, an encoding device encodes a vertex to be encoded using an encoded vertex, in order to efficiently encode the vertex. Specifically, in encoding of a vertex to be encoded, an encoding device predicts a vertex to be encoded using an encoded vertex and encodes the difference between the predicted vertex and the vertex to be encoded, thereby reducing the code amount.

For example, when the inter-prediction is used for a three-dimensional mesh frame to be encoded, a vertex to be encoded is encoded using a vertex in an encoded three-dimensional mesh frame. When the intra-prediction is used for a three-dimensional mesh frame to be encoded, a vertex to be encoded is encoded using an encoded vertex in the three-dimensional mesh frame to be encoded.

In this way, the prediction processing can be adaptively switched between the inter-prediction and the intra-prediction on a three-dimensional mesh frame basis, thereby reducing the code amount.

However, a vertex that can be efficiently encoded using the inter-prediction and a vertex that can be efficiently encoded using the intra-prediction may be included in the same three-dimensional mesh frame. Therefore, the code amount may be inadequately reduced.

In view of this, an encoding method of Example 1 includes: encoding, into a bitstream, first reference information for a first set of vertices in a first three-dimensional mesh frame and second reference information for a second set of vertices in the first three-dimensional mesh frame; encoding the first set of vertices into the bitstream; and encoding the second set of vertices into the bitstream, in which the first reference information indicates a first value when a third set of vertices in a second three-dimensional mesh frame is used for the encoding of the first set of vertices, the second three-dimensional mesh frame being temporally different from the first three-dimensional mesh frame, and the second reference information indicates a second value when a fourth set of vertices in the first three-dimensional mesh frame is used for the encoding of the second set of vertices.

Accordingly, in encoding of the first vertex set and the second vertex set in the same three-dimensional mesh frame, it may be possible to apply the inter-prediction to the first vertex set and apply the intra-prediction to the second vertex set. Therefore, the code amount may be able to be reduced.

Moreover, an encoding method of Example 2 may be the encoding method of Example 1, in which when the third set of vertices is used for the encoding of the first set of vertices, the first set of vertices is encoded using connection information of a three-dimensional mesh in the second three-dimensional mesh frame.

Accordingly, the connection information may be able to be reused in the inter-prediction. Therefore, encoding of the connection information may be able to be omitted in the inter-prediction. Therefore, the code amount of the connection information may be able to be omitted in the inter-prediction.

Moreover, an encoding method of Example 3 may be the encoding method of Example 1, in which regardless of (i) whether the third set of vertices is used for the encoding of the first set of vertices and (ii) whether the fourth set of vertices is used for the encoding of the second set of vertices, the first set of vertices and the second set of vertices are encoded using connection information of a three-dimensional mesh in the second three-dimensional mesh frame.

Accordingly, regardless of whether in the inter-prediction or the intra-prediction, the connection information may be able to be reused. Therefore, regardless of whether in the inter-prediction or the intra-prediction, encoding of the connection information may be able to be omitted. Therefore, regardless of whether in the inter-prediction or the intra-prediction, the code amount of the connection information may be able to be omitted.

Moreover, an encoding method of Example 4 may be the encoding method of any of Examples 1 to 3, in which each of the first reference information and the second reference information indicates a value for identifying a three-dimensional mesh frame to be referred to.

Accordingly, the three-dimensional mesh frame to be referred to may be able to be efficiently specified.

Moreover, an encoding method of Example 5 may be the encoding method of any of Examples 1 to 4, in which each of the first reference information and the second reference information indicates, as a value, whether the second three-dimensional mesh frame is to be referred to.

Accordingly, whether the inter-prediction is used or not may be able to be efficiently specified.

Moreover, an encoding method of Example 6 may be the encoding method of any of Examples 1 to 5, in which each of the first reference information and the second reference information indicates, as a value, whether the first three-dimensional mesh frame is to be referred to.

Accordingly, whether the intra-prediction is used or not may be able to be efficiently specified.

Moreover, an encoding method of Example 7 may be the encoding method of any of Examples 1 to 6, in which the first three-dimensional mesh frame is a three-dimensional mesh frame to be encoded.

Accordingly, each vertex set in the three-dimensional mesh frame to be encoded may be able to be efficiently encoded.

Moreover, an encoding method of Example 8 may be the encoding method of any of Examples 1 to 7, in which the second three-dimensional mesh frame is an encoded three-dimensional mesh frame.

Accordingly, when the inter-prediction is used for encoding of the first vertex set, the first vertex set may be able to be efficiently encoded using the encoded three-dimensional mesh frame.

Moreover, a decoding method of Example 9 includes: decoding, from a bitstream, first reference information for a first set of vertices in a first three-dimensional mesh frame and second reference information for a second set of vertices in the first three-dimensional mesh frame; decoding the first set of vertices from the bitstream using a third set of vertices in a second three-dimensional mesh frame when the first reference information indicates a first value, the second three-dimensional mesh frame being temporally different from the first three-dimensional mesh frame; and decoding the second set of vertices from the bitstream using a fourth set of vertices in the first three-dimensional mesh frame when the second reference information indicates a second value.

Accordingly, in decoding of the first vertex set and the second vertex set in the same three-dimensional mesh frame, it may be possible to apply the inter-prediction to the first vertex set and apply the intra-prediction to the second vertex set. Therefore, the code amount may be able to be reduced.

Moreover, a decoding method of Example 10 may be the decoding method of Example 9, in which when the first reference information indicates the first value, the first set of vertices is decoded using connection information of a three-dimensional mesh in the second three-dimensional mesh frame.

Accordingly, the connection information may be able to be reused in the inter-prediction. Therefore, decoding of the connection information may be able to be omitted in the inter-prediction. Therefore, the code amount of the connection information may be able to be omitted in the inter-prediction.

Moreover, a decoding method of Example 11 may be the decoding method of Example 9, in which regardless of (i) whether the first reference information indicates the first value or indicates the second value and (ii) whether the second reference information indicates the first value or indicates the second value, the first set of vertices and the second set of vertices are decoded using connection information of a three-dimensional mesh in the second three-dimensional mesh frame.

Accordingly, regardless of whether in the inter-prediction or the intra-prediction, the connection information may be able to reused. Therefore, regardless of whether in the inter-prediction or the intra-prediction, decoding of the connection information may be able to be omitted. Therefore, regardless of whether in the inter-prediction or the intra-prediction, the code amount of the connection information may be able to be omitted.

Moreover, a decoding method of Example 12 may be the decoding method of any of Examples 9 to 11, in which each of the first reference information and the second reference information indicates a value for identifying a three-dimensional mesh frame to be referred to.

Accordingly, the three-dimensional mesh frame to be referred to may be able to be efficiently specified.

Moreover, a decoding method of Example 13 may be the decoding method of any of Examples 9 to 12, in which each of the first reference information and the second reference information indicates, as a value, whether the second three-dimensional mesh frame is to be referred to.

Accordingly, whether the inter-prediction is used or not may be able to be efficiently specified.

Moreover, a decoding method of Example 14 may be the decoding method of any of Examples 9 to 13, in which each of the first reference information and the second reference information indicates, as a value, whether the first three-dimensional mesh frame is to be referred to.

Accordingly, whether the intra-prediction is used or not may be able to be efficiently specified.

Moreover, a decoding method of Example 15 may be the decoding method of any of Examples 9 to 14, in which the first three-dimensional mesh frame is a three-dimensional mesh frame to be decoded.

Accordingly, each vertex set in the three-dimensional mesh frame to be decoded may be able to be efficiently decoded.

Moreover, a decoding method of Example 16 may be the decoding method of any of Examples 9 to 15, in which the second three-dimensional mesh frame is a decoded three-dimensional mesh frame.

Accordingly, when the inter-prediction is used for decoding of the first vertex set, the first vertex set may be able to be efficiently decoded using the decoded three-dimensional mesh frame.

Moreover, an encoding device of Example 17 includes: memory; and a circuit accessible to the memory, in which in operation, the circuit: encodes, into a bitstream, first reference information for a first set of vertices in a first three-dimensional mesh frame and second reference information for a second set of vertices in the first three-dimensional mesh frame; encodes the first set of vertices into the bitstream; and encodes the second set of vertices into the bitstream, the first reference information indicates a first value when a third set of vertices in a second three-dimensional mesh frame is used for the encoding of the first set of vertices, the second three-dimensional mesh frame being temporally different from the first three-dimensional mesh frame, and the second reference information indicates a second value when a fourth set of vertices in the first three-dimensional mesh frame is used for the encoding of the second set of vertices.

Accordingly, in encoding of the first vertex set and the second vertex set in the same three-dimensional mesh frame, it may be possible to apply the inter-prediction to the first vertex set and apply the intra-prediction to the second vertex set. Therefore, the code amount may be able to be reduced.

Moreover, a decoding device of Example 18 includes: memory; and a circuit accessible to the memory, in which in operation, the circuit: decodes, from a bitstream, first reference information for a first set of vertices in a first three-dimensional mesh frame and second reference information for a second set of vertices in the first three-dimensional mesh frame; decodes the first set of vertices from the bitstream using a third set of vertices in a second three-dimensional mesh frame when the first reference information indicates a first value, the second three-dimensional mesh frame being temporally different from the first three-dimensional mesh frame; and decodes the second set of vertices from the bitstream using a fourth set of vertices in the first three-dimensional mesh frame when the second reference information indicates a second value.

Accordingly, in decoding of the first vertex set and the second vertex set in the same three-dimensional mesh frame, it may be possible to apply the inter-prediction to the first vertex set and apply the intra-prediction to the second vertex set. Therefore, the code amount may be able to be reduced.

Moreover, these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### Expressions and Terms

The following expressions and terms will be used herein.

### (1) Three-Dimensional Mesh

A three-dimensional mesh is a set of a plurality of faces and indicates, for example, a three-dimensional object. In addition, a three-dimensional mesh is mainly constituted of vertex information, connection information, and attribute information. A three-dimensional mesh may be expressed as a polygon mesh or a mesh. In addition, a three-dimensional mesh may have a temporal change. A three-dimensional mesh may include metadata related to vertex information, connection information, and attribute information or other additional information.

### (2) Vertex Information

Vertex information is information indicating a vertex. For example, vertex information indicates a position of a vertex in a three-dimensional space. In addition, a vertex corresponds to a vertex of a face that constitutes a three-dimensional mesh. Vertex information may be expressed as “geometry”. In addition, vertex information may also be expressed as position information.

### (3) Connection Information

Connection information is information indicating a connection between vertexes. For example, connection information indicates a connection for constructing a face or an edge of a three-dimensional mesh. Connection information may be expressed as “connectivity”. In addition, connection information may also be expressed as face information.

### (4) Attribute Information

Attribute information is information indicating an attribute of a vertex or a face. For example, attribute information indicates an attribute such as a color, an image, a normal vector, and the like associated with a vertex or a face. Attribute information may be expressed as “texture”.

### (5) Face

A face is an element that constitutes a three-dimensional mesh. Specifically, a face is a polygon on a plane in a three-dimensional space. For example, a face can be determined as a triangle in the three-dimensional space.

### (6) Plane

A plane is a two-dimensional plane in a three-dimensional space. For example, a polygon is formed on a plane and a plurality of polygons are formed on a plurality of planes.

### (7) Bitstream

A bitstream corresponds to encoded information. A bitstream can also be expressed as a stream, an encoded bitstream, a compressed bitstream, or an encoded signal.

### (8) Encoding and Decoding

The expression “encode” may be replaced with expressions such as store, include, write, describe, signalize, send out, notify, save, or compress and such expressions may be interchangeably used. For example, encoding information may mean including information in a bitstream. In addition, encoding information in a bitstream may mean encoding the information and generating a bitstream that includes the encoded information.

In addition, the expression “decode” may be replaced with expressions such as read, interpret, scan, load, derive, acquire, receive, extract, restore, reconstruct, decompress, or expand and such expressions may be interchangeably used. For example, decoding information may mean acquiring information from a bitstream. In addition, decoding information from a bitstream may mean decoding the bitstream and acquiring information included in the bitstream.

### (9) Ordinal Numbers

In the description, an ordinal number such as first, second, or the like may be affixed to a constituent element or the like. Such ordinal numbers may be replaced as necessary. In addition, an ordinal number may be newly affixed to or removed from a constituent element or the like. Furthermore, the ordinal numbers may be affixed to elements in order to identify the elements and may not correspond to any meaningful order.

### <Three-Dimensional Mesh>

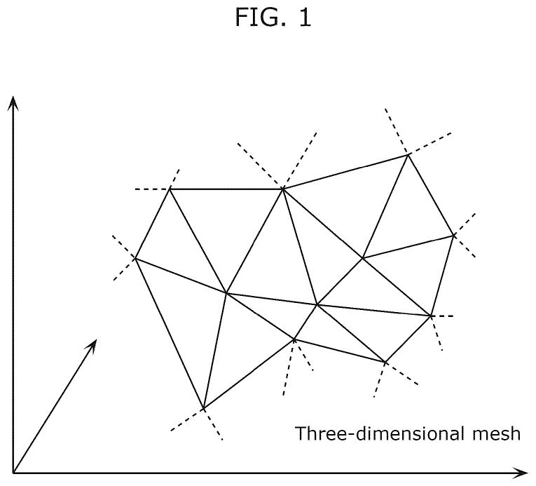

FIG. 1 is a conceptual diagram illustrating a three-dimensional mesh according to the present embodiment. The three-dimensional mesh is constituted of a plurality of faces. For example, each face is a triangle. Vertexes of the triangles are determined in a three-dimensional space. In addition, a three-dimensional mesh indicates a three-dimensional object. Each face may have a color or an image.

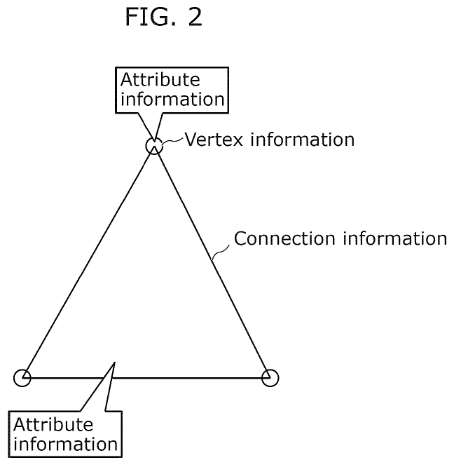

FIG. 2 is a conceptual diagram illustrating basic elements of a three-dimensional mesh according to the present embodiment. The three-dimensional mesh is constituted of vertex information, connection information, and attribute information. Vertex information indicates a position of a vertex of a face in a three-dimensional space. Connection information indicates a connection between vertexes. A face can be identified based on vertex information and connection information. In other words, an uncolored three-dimensional object is formed in a three-dimensional space based on vertex information and connection information.

Attribute information may be associated with a vertex or associated with a face. Attribute information associated with a vertex may be expressed as “attribute per point”. Attribute information associated with a vertex may indicate an attribute of the vertex itself or indicate an attribute of a face connected to the vertex.

For example, a color may be associated with a vertex as attribute information. The color associated with the vertex may be the color of the vertex or the color of a face connected to the vertex. The color of the face may be an average of a plurality of colors associated with a plurality of vertexes of the face. In addition, a normal vector may be associated with a vertex or a face as attribute information. Such a normal vector can express a front and a rear of a face.

In addition, a two-dimensional image may be associated with a face as attribute information. The two-dimensional image associated with a face is also expressed as a texture image or an “attribute map”. In addition, information indicating mapping between a face and a two-dimensional image may be associated with the face as attribute information. Such information indicating mapping may be expressed as mapping information, vertex information of a texture image, or an “attribute UV coordinate”.

Furthermore, information on a color, an image, a moving image, and the like to be used as attribute information may be expressed as “parametric space”.

A texture is reflected in a three-dimensional object based on such attribute information. In other words, a colored three-dimensional object is formed in a three-dimensional space based on vertex information, connection information, and attribute information.

Note that while attribute information is associated with a vertex or a face in the description given above, alternatively, attribute information may be associated with an edge.

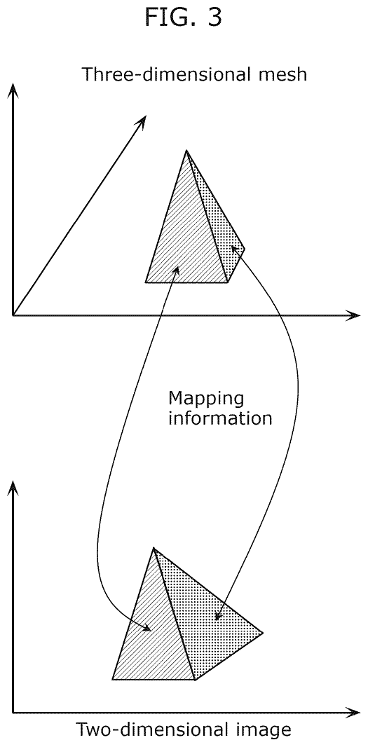

FIG. 3 is a conceptual diagram illustrating mapping according to the present embodiment. For example, a region of a two-dimensional image on a two-dimensional plane can be mapped to a face of a three-dimensional mesh in a three-dimensional space. Specifically, coordinate information of a region in the two-dimensional image is associated with a face of the three-dimensional mesh. Accordingly, an image of the mapped region in the two-dimensional image is reflected in the face of the three-dimensional mesh.

The use of mapping enables a two-dimensional image to be used as attribute information to be separated from the three-dimensional mesh. For example, in encoding of the three-dimensional mesh, the two-dimensional image may be encoded based on an image encoding system or a video encoding system.

### <System Configuration>

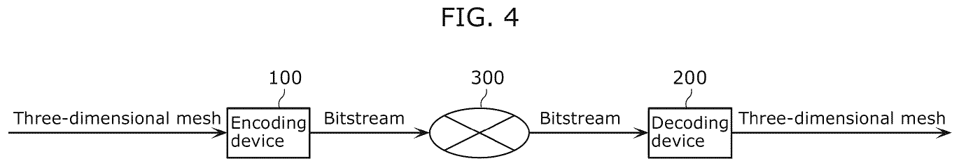

FIG. 4 is a block diagram illustrating a configuration example of an encoding/decoding system according to the present embodiment. In FIG. 4, the encoding/decoding system includes encoding device 100 and decoding device 200.

For example, encoding device 100 acquires a three-dimensional mesh and encodes the three-dimensional mesh into a bitstream. In addition, encoding device 100 outputs the bitstream to network 300. For example, the bitstream includes an encoded three-dimensional mesh and control information for decoding the encoded three-dimensional mesh. Encoding of the three-dimensional mesh causes information of the three-dimensional mesh to be compressed.

Network 300 transmits the bitstream from encoding device 100 to decoding device 200. Network 300 may be the Internet, a wide area network (WAN), a local area network (LAN), or a combination thereof. Network 300 is not necessarily limited to two-way communication and may be a unidirectional communication network for terrestrial digital broadcasting, satellite broadcasting, or the like.

In addition, network 300 may be replaced with a recording medium such as a DVD (digital versatile disc), a BD (Blu-Ray Disc (registered trademark)), or the like.

Decoding device 200 acquires a bitstream and decodes a three-dimensional mesh from the bitstream. Decoding of the three-dimensional mesh causes information of the three-dimensional mesh to be expanded. For example, decoding device 200 decodes a three-dimensional mesh according to a decoding method corresponding to an encoding method used by encoding device 100 to encode the three-dimensional mesh. In other words, encoding device 100 and decoding device 200 perform encoding and decoding according to an encoding method and a decoding method which correspond to each other.

Note that the three-dimensional mesh before encoding can also be expressed as an original three-dimensional mesh. In addition, the three-dimensional mesh after decoding is also expressed as a reconstructed three-dimensional mesh.

### <Encoding Device>

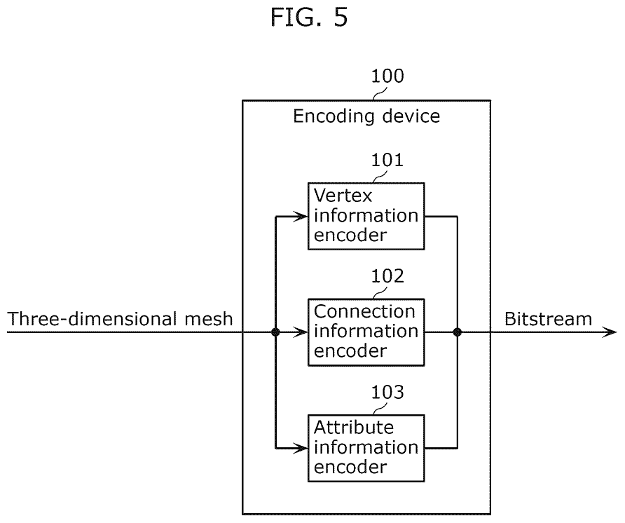

FIG. 5 is a block diagram illustrating a configuration example of encoding device 100 according to the present embodiment. For example, encoding device 100 includes vertex information encoder 101, connection information encoder 102, and attribute information encoder 103.

Vertex information encoder 101 is an electric circuit which encodes vertex information. For example, vertex information encoder 101 encodes vertex information into a bitstream according to a format defined with respect to the vertex information.

Connection information encoder 102 is an electric circuit which encodes connection information. For example, connection information encoder 102 encodes connection information into a bitstream according to a format defined with respect to the connection information.

Attribute information encoder 103 is an electric circuit which encodes attribute information. For example, attribute information encoder 103 encodes attribute information into a bitstream according to a format defined with respect to the attribute information.

Variable-length coding or fixed length coding may be used for encoding vertex information, connection information, and attribute information. The variable-length coding may accommodate Huffman coding, context-adaptive binary arithmetic coding (CABAC), or the like.

Vertex information encoder 101, connection information encoder 102, and attribute information encoder 103 may be integrated. Alternatively, each of vertex information encoder 101, connection information encoder 102, and attribute information encoder 103 may be more finely segmentalized into a plurality of constituent elements.

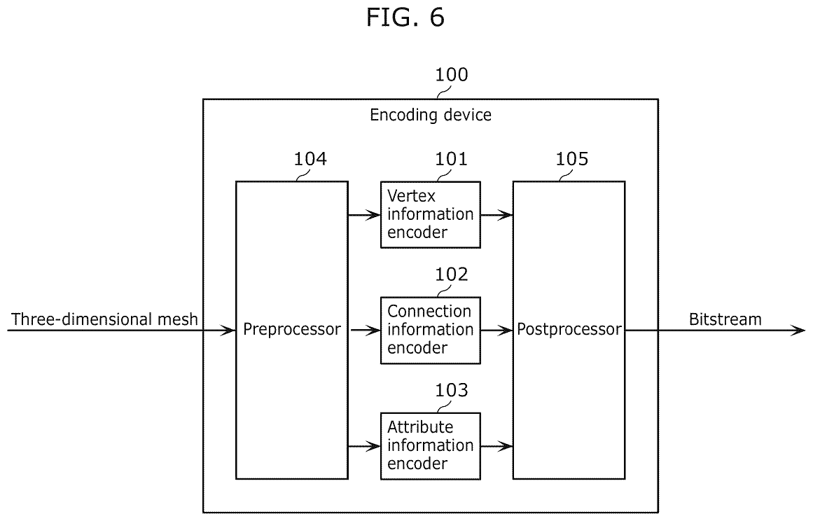

FIG. 6 is a block diagram illustrating another configuration example of encoding device 100 according to the present embodiment. For example, in addition to the components illustrated in FIG. 5, encoding device 100 includes preprocessor 104 and postprocessor 105.

Preprocessor 104 is an electric circuit which performs processing before encoding of vertex information, connection information, and attribute information. For example, preprocessor 104 may perform transformation processing, demultiplexing, multiplexing, or the like with respect to a three-dimensional mesh before encoding. More specifically, for example, preprocessor 104 may demultiplex vertex information, connection information, and attribute information from the three-dimensional mesh before encoding.

Postprocessor 105 is an electric circuit which performs processing after the encoding of vertex information, connection information, and attribute information. For example, postprocessor 105 may perform transformation processing, demultiplexing, multiplexing, or the like with respect to vertex information, connection information, and attribute information after encoding. More specifically, for example, postprocessor 105 may multiplex vertex information, connection information, and attribute information after encoding into a bitstream. In addition, for example, postprocessor 105 may further perform variable-length coding with respect to vertex information, connection information, and attribute information after the encoding.

### <Decoding Device>

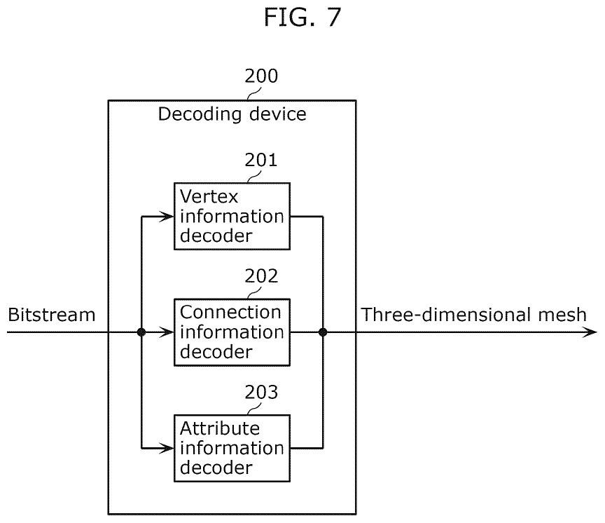

FIG. 7 is a block diagram illustrating a configuration example of decoding device 200 according to the present embodiment. For example, decoding device 200 includes vertex information decoder 201, connection information decoder 202, and attribute information decoder 203.

Vertex information decoder 201 is an electric circuit which decodes vertex information. For example, vertex information decoder 201 decodes vertex information from a bitstream according to a format defined with respect to the vertex information.

Connection information decoder 202 is an electric circuit which decodes connection information. For example, connection information decoder 202 decodes connection information from a bitstream according to a format defined with respect to the connection information.

Attribute information decoder 203 is an electric circuit which decodes attribute information. For example, attribute information decoder 203 decodes attribute information from a bitstream according to a format defined with respect to the attribute information.

Variable-length decoding or fixed length decoding may be used for decoding vertex information, connection information, and attribute information. The variable-length decoding may accommodate Huffman coding, context-adaptive binary arithmetic coding (CABAC), or the like.

Vertex information decoder 201, connection information decoder 202, and attribute information decoder 203 may be integrated. Alternatively, each of vertex information decoder 201, connection information decoder 202, and attribute information decoder 203 may be more finely segmentalized into a plurality of constituent elements.

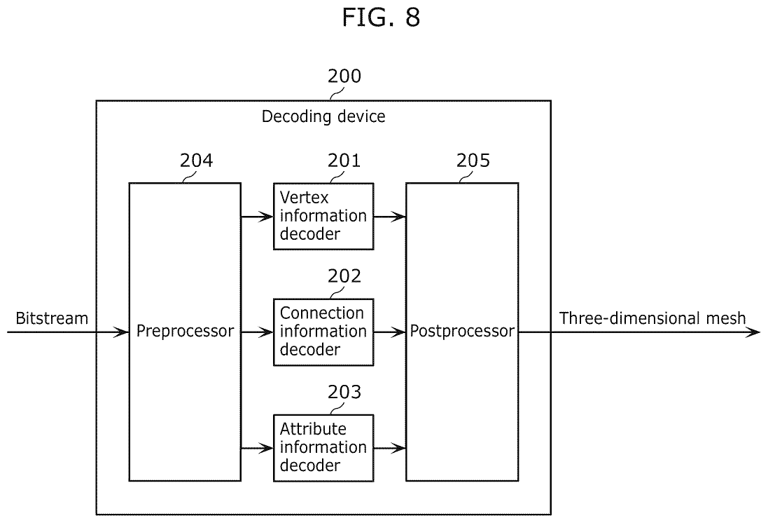

FIG. 8 is a block diagram illustrating another configuration example of decoding device 200 according to the present embodiment. For example, in addition to the components illustrated in FIG. 7, decoding device 200 includes preprocessor 204 and postprocessor 205.

Preprocessor 204 is an electric circuit which performs processing before decoding of vertex information, connection information, and attribute information. For example, preprocessor 204 may perform transformation processing, demultiplexing, multiplexing, or the like with respect to a bitstream before decoding of vertex information, connection information, and attribute information.

More specifically, for example, preprocessor 204 may demultiplex, from a bitstream, a sub-bitstream corresponding to vertex information, a sub-bitstream corresponding to connection information, and a sub-bitstream corresponding to attribute information. In addition, for example, preprocessor 204 may perform variable-length decoding with respect to the bitstream in advance before decoding of vertex information, connection information, and attribute information.

Postprocessor 205 is an electric circuit which performs processing after the decoding of vertex information, connection information, and attribute information. For example, postprocessor 205 may perform transformation processing, demultiplexing, multiplexing, or the like with respect to vertex information, connection information, and attribute information after decoding. More specifically, for example, postprocessor 205 may multiplex vertex information, connection information, and attribute information after decoding into a three-dimensional mesh.

### <Bitstream>

Vertex information, connection information, and attribute information are encoded and stored in a bitstream. A relationship between these pieces of information and the bitstream will be described below.

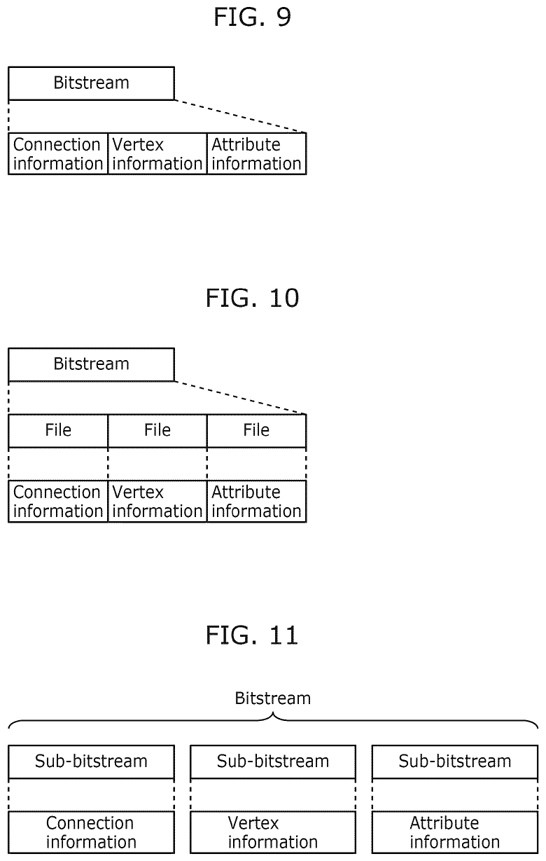

FIG. 9 is a conceptual diagram illustrating a configuration example of a bitstream according to the present embodiment. In this example, connection information, vertex information, and attribute information are integrated in the bitstream. For example, connection information, vertex information, and attribute information may be included in one file.

In addition, a plurality of portions of the pieces of information may be sequentially stored such as a first portion of connection information, a first portion of vertex information, a first portion of attribute information, a second portion of connection information, a second portion of vertex information, a second portion of attribute information, . . . . The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 10 is a conceptual diagram illustrating another configuration example of a bitstream according to the present embodiment. In the example, a plurality of files are included in a bitstream and connection information, vertex information, and attribute information are respectively stored in different files. While a file including connection information, a file including vertex information, and a file including attribute information are illustrated here, storage formats are not limited to this example. For example, two types of information among connection information, vertex information, and attribute information may be included in one file and the one remaining type of information may be included in another file.

Alternatively, the pieces of information can be stored by being divided into a larger number of files. For example, a plurality of portions of connection information may be stored in a plurality of files, a plurality of portions of vertex information may be stored in a plurality of files, and a plurality of portions of attribute information may be stored in a plurality of files. The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 11 is a conceptual diagram illustrating another configuration example of a bitstream according to the present embodiment. In the example, a bitstream is constituted of a plurality of separable sub-bitstreams and connection information, vertex information, and attribute information are respectively stored in different sub-bitstreams.

While a sub-bitstream including connection information, a sub-bitstream including vertex information, and a sub-bitstream including attribute information are illustrated here, storage formats are not limited to this example.

For example, two types of information among connection information, vertex information, and attribute information may be included in one sub-bitstream and the one remaining type of information may be included in another sub-bitstream. Specifically, attribute information such as a two-dimensional image may be stored in a sub-bitstream conforming to an image coding system separately from a sub-bitstream of connection information and vertex information.

In addition, each sub-bitstream may include a plurality of files. Furthermore, a plurality of portions of connection information may be stored in a plurality of files, a plurality of portions of vertex information may be stored in a plurality of files, and a plurality of portions of attribute information may be stored in a plurality of files.

Furthermore, an order of storage of connection information, vertex information, and attribute information is not limited to the example illustrated in FIG. 9, FIG. 10, and FIG. 11, and an order of storage that differs from this example may be used. For example, vertex information, connection information, and attribute information may be stored in a bitstream in this order. Alternatively, in an order other than this order, e.g., in any of orders: connection information, attribute information, and vertex information; vertex information, attribute information, and connection information; attribute information, connection information, and vertex information; and attribute information, vertex information, and connection information, these pieces of information may be stored in a bitstream.

Furthermore, each of connection information, vertex information, and attribute information may be divided into a plurality of data items, and the plurality of data items may be stored in a bitstream in a periodic order or in a random order.

### Specific Example

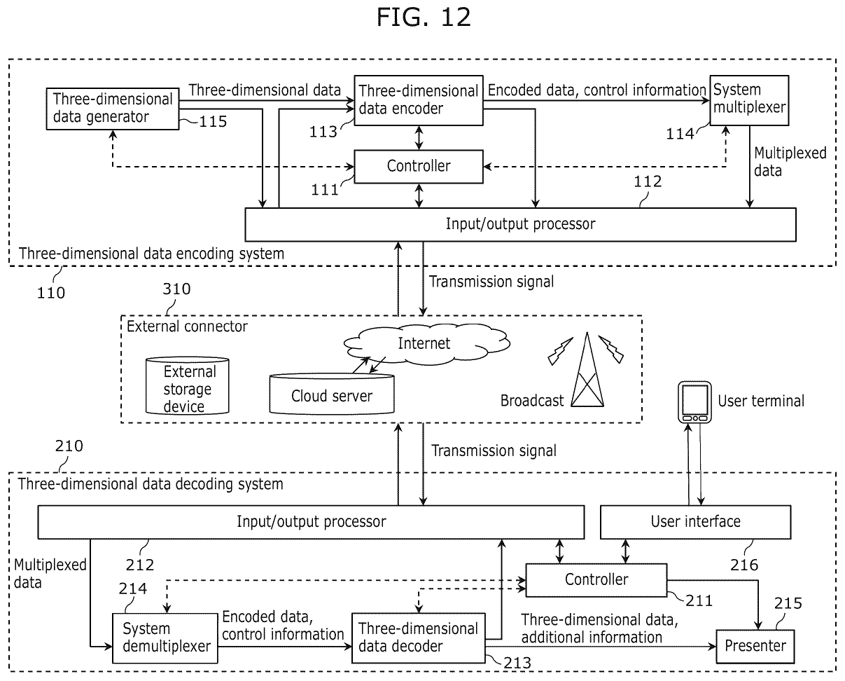

FIG. 12 is a block diagram illustrating a specific example of the encoding/decoding system according to the present embodiment. In FIG. 12, the encoding/decoding system includes three-dimensional data encoding system 110, three-dimensional data decoding system 210, and external connector 310.

Three-dimensional data encoding system 110 includes controller 111, input/output processor 112, three-dimensional data encoder 113, three-dimensional data generator 115, and system multiplexer 114. Three-dimensional data decoding system 210 includes controller 211, input/output processor 212, three-dimensional data decoder 213, system demultiplexer 214, presenter 215, and user interface 216.

In three-dimensional data encoding system 110, sensor data is input from a sensor terminal to three-dimensional data generator 115. Three-dimensional data generator 115 generates three-dimensional data that is point cloud data, mesh data, or the like from the sensor data and inputs the three-dimensional data to three-dimensional data encoder 113.

For example, three-dimensional data generator 115 generates vertex information and generates connection information and attribute information which correspond to the vertex information. Three-dimensional data generator 115 may process vertex information when generating connection information and attribute information. For example, three-dimensional data generator 115 may reduce a data amount by deleting overlapping vertexes or transform vertex information (position shift, rotation, normalization, or the like). In addition, three-dimensional data generator 115 may render attribute information.

While three-dimensional data generator 115 is a constituent element of three-dimensional data encoding system 110 in FIG. 12, three-dimensional data generator 115 may be disposed on the outside independent of three-dimensional data encoding system 110.

For example, a sensor terminal that provides sensor data for generating three-dimensional data may be a mobile object such as an automobile, a flying object such as an airplane, a mobile terminal, a camera, or the like. Alternatively, a range sensor such as LIDAR, a millimeter-wave radar, an infrared sensor, or a range finder, a stereo camera, a combination of a plurality of monocular cameras, or the like may be used as the sensor terminal.

The sensor data may be a distance (position) of an object, a monocular camera image, a stereo camera image, a color, a reflectance, an attitude or an orientation of a sensor, a gyro, a sensing position (GPS information or elevation), a velocity, an acceleration, a time of day of sensing, air temperature, air pressure, humidity, magnetism, or the like.

Three-dimensional data encoder 113 corresponds to encoding device 100 illustrated in FIG. 5 and the like. For example, three-dimensional data encoder 113 encodes three-dimensional data and generates encoded data. In addition, three-dimensional data encoder 113 generates control information when encoding the three-dimensional data. Furthermore, three-dimensional data encoder 113 inputs the encoded data to system multiplexer 114 together with the control information.

The encoding system of three-dimensional data may be an encoding system using geometry or an encoding system using a video codec. In this case, an encoding system using geometry may also be expressed as a geometry-based encoding system. An encoding system using a video codec may also be expressed as a video-based encoding system.

System multiplexer 114 multiplexes encoded data and control information input from three-dimensional data encoder 113 and generates multiplexed data using a prescribed multiplexing system. System multiplexer 114 may multiplex other media such as video, audio, subtitles, application data, or document files, reference time information, or the like together with the encoded data and control information of three-dimensional data. Furthermore, system multiplexer 114 may multiplex attribute information related to sensor data or three-dimensional data.

For example, multiplexed data has a file format for accumulation, a packet format for transmission, or the like. ISOBMFF or an ISOBMFF-based system may be used as an accumulation system or a transmission system. Alternatively, MPEG-DASH, MMT, MPEG-2 TS Systems, RTP, or the like may be used.

In addition, multiplexed data is output as a transmission signal by input/output processor 112 to external connector 310. The multiplexed data may be transmitted as a transmission signal in a wired manner or in a wireless manner. Alternatively, the multiplexed data is accumulated in an internal memory or a storage device. The multiplexed data may be transmitted via the Internet to a cloud server or stored in an external storage device.

For example, the transmission or accumulation of the multiplexed data is performed by a method in accordance with a medium for transmission or accumulation such as broadcasting or communication. As a communication protocol, http, ftp, TCP, UDP, IP, or a combination thereof may be used. In addition, a pull-type communication scheme may be used or a push-type communication scheme may be used.

Ethernet (registered trademark), USB, RS-232C, HDMI (registered trademark), a coaxial cable, or the like may be used for wired transmission. In addition, 3GPP (registered trademark), 3G/4G/5G as specified by IEEE, a wireless LAN, Bluetooth, or a millimeter-wave may be used for wireless transmission. Furthermore, for example, DVB-T2, DVB-S2, DVB-C2, ATSC 3.0, ISDB-S3, or the like may be used as a broadcasting system.

Note that sensor data may be input to three-dimensional data generator 115 or system multiplexer 114. In addition, three-dimensional data or encoded data may be output as-is as a transmission signal to external connector 310 via input/output processor 112. The transmission signal output from three-dimensional data encoding system 110 is input to three-dimensional data decoding system 210 via external connector 310.

In addition, each operation of three-dimensional data encoding system 110 may be controlled by controller 111 which executes application programs.

In three-dimensional data decoding system 210, a transmission signal is input to input/output processor 212. Input/output processor 212 decodes multiplexed data having a file format or a packet format from the transmission signal and inputs the multiplexed data to system demultiplexer 214. System demultiplexer 214 acquires encoded data and control information from the multiplexed data and inputs the encoded data and the control information to three-dimensional data decoder 213. System demultiplexer 214 may extract other media, reference time information, or the like from the multiplexed data.

Three-dimensional data decoder 213 corresponds to decoding device 200 illustrated in FIG. 7 and the like. For example, three-dimensional data decoder 213 decodes three-dimensional data from the encoded data based on an encoding system specified in advance. Subsequently, the three-dimensional data is presented to a user by presenter 215.

In addition, additional information such as sensor data may be input to presenter 215. Presenter 215 may present three-dimensional data based on the additional information. In addition, an instruction by the user may be input to user interface 216 from a user terminal. Furthermore, presenter 215 may present three-dimensional data based on the input instruction.

Note that input/output processor 212 may acquire three-dimensional data and encoded data from external connector 310.

In addition, each operation of three-dimensional data decoding system 210 may be controlled by controller 211 which executes application programs.

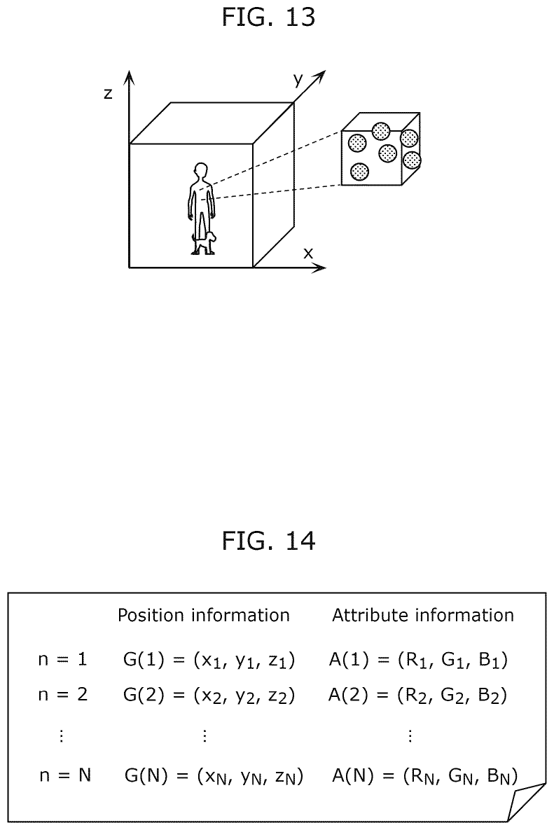

FIG. 13 is a conceptual diagram illustrating a configuration example of point cloud data according to the present embodiment. Point cloud data refers to data of a point cloud that indicates a three-dimensional object.

Specifically, a point cloud is constituted of a plurality of points and has position information which indicates a three-dimensional coordinate position of each point and attribute information which indicates an attribute of each point. The position information is also expressed as geometry.

For example, a type of attribute information may be a color, a reflectance, or the like. Attribute information related to one type may be associated with one point, attribute information related to a plurality of different types may be associated with one point, or attribute information having a plurality of values with respect to a same type may be associated with one point.

FIG. 14 is a conceptual diagram illustrating a data file example of the point cloud data according to the present embodiment. The example is an example of a case where items of position information and items of attribute information have a one-to-one correspondence and the example indicates position information and attribute information of N-number of points which constitute the point cloud data. In this example, position information is information indicating a three-dimensional coordinate position by three axes of x, y, and z and attribute information is information indicating a color by RGB. As a representative data file of point cloud data, a PLY file or the like can be used.

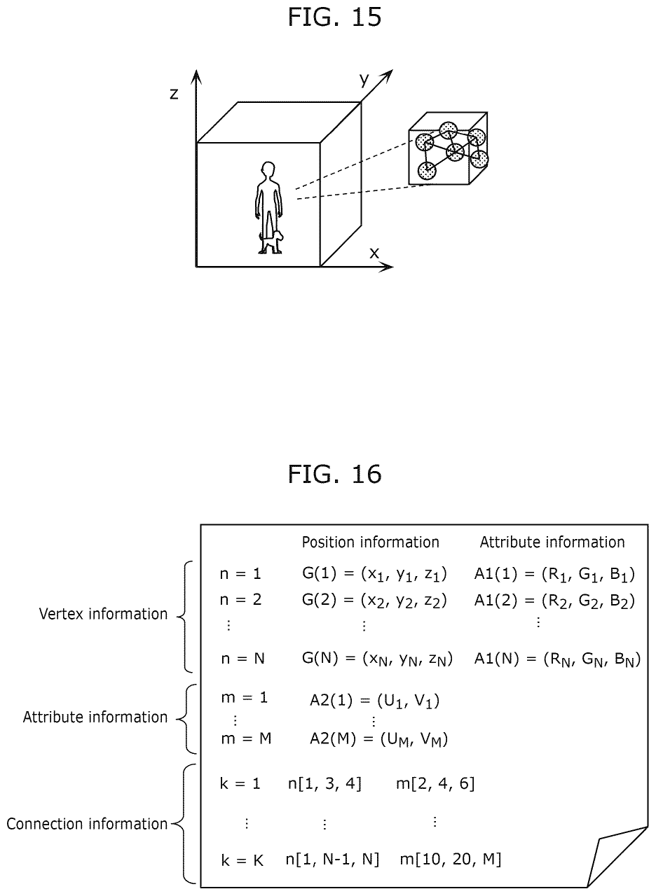

FIG. 15 is a conceptual diagram illustrating a configuration example of mesh data according to the present embodiment. Mesh data is data used in CG (computer graphics) or the like and is data of a three-dimensional mesh which represents a three-dimensional shape of an object by a plurality of faces. Each face is also expressed as a polygon and has a polygonal shape such as a triangle or a quadrilateral.

Specifically, in addition to the plurality of points which constitute a point cloud, a three-dimensional mesh is constituted of a plurality of edges and a plurality of faces. Each point is also expressed as a vertex or a position. Each edge corresponds to a line segment which connects two vertexes. Each face corresponds to an area enclosed by three or more edges.

In addition, a three-dimensional mesh has position information indicating three-dimensional coordinate positions of vertexes. The position information is also expressed as vertex information or geometry. Furthermore, a three-dimensional mesh has connection information indicating a relationship among a plurality of vertexes constituting an edge or a face. The connection information is also expressed as connectivity. In addition, a three-dimensional mesh has attribute information indicating an attribute with respect to a vertex, an edge, or a face. The attribute information in a three-dimensional mesh is also expressed as a texture.

For example, attribute information may indicate a color, a reflectance, or a normal vector with respect to a vertex, an edge, or a face. An orientation of a normal vector can express a front and a rear of a face.

An object file or the like may be used as a data file format of mesh data.

FIG. 16 is a conceptual diagram illustrating a data file example of the mesh data according to the present embodiment. In the example, a data file includes pieces of position information G(1) to G(N) and pieces of attribute information A1(1) to A1(N) of N-number of vertexes which constitute a three-dimensional mesh. In addition, in the example, M-number of pieces of attribute information A2(1) to A2(M) are included. An item of attribute information need not correspond one-to-one to a vertex and need not correspond one-to-one to a face. In addition, attribute information need not exist.

Connection information is indicated by a combination of indexes of vertexes. n [1, 3, 4] indicates a face of a triangle constituted of three vertexes n=1, n=3, and n=4. In addition, m [2, 4, 6] indicates that pieces of attribute information m=2, m=4, and M=6 respectively correspond to the three vertexes.

In addition, a substantive content of the attribute information may be described in a separate file. Furthermore, a pointer with respect to the content may be associated with a vertex, a face, or the like. For example, attribute information indicating an image with respect to a face may be stored in a two-dimensional attribute map file. In addition, a file name of the attribute map and a two-dimensional coordinate value in the attribute map may be described in pieces of attribute information A2(1) to A2(M). Methods of designating attribute information with respect to a face are not limited to these methods and any kind of method may be used.

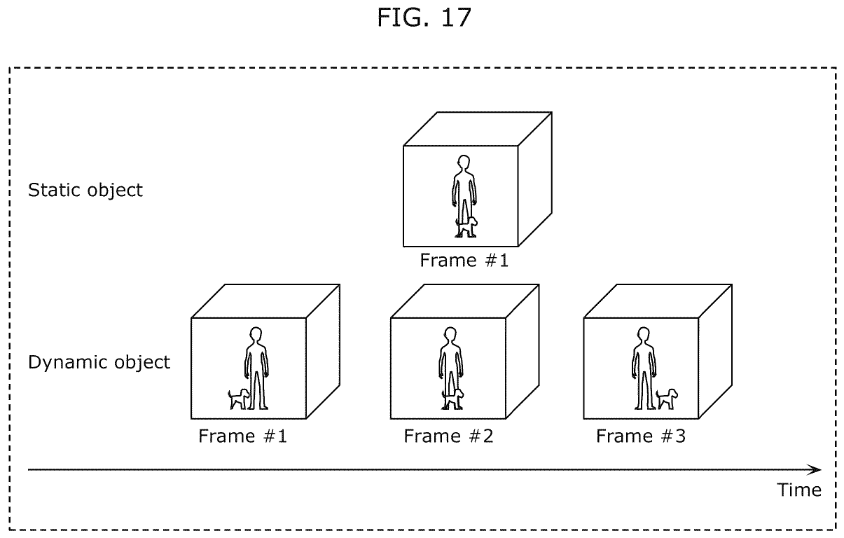

FIG. 17 is a conceptual diagram illustrating a type of three-dimensional data according to the present embodiment. Point cloud data and mesh data may either indicate a static object or a dynamic object. A static object is an object that does not temporally change and a dynamic object is an object that temporally changes. A static object may correspond to three-dimensional data with respect to an arbitrary time point.

For example, point cloud data with respect to an arbitrary time point may be expressed as a PCC frame. In addition, mesh data with respect to an arbitrary time point may be expressed as a mesh frame. Furthermore, a PCC frame and a mesh frame may be simply expressed as a frame.

In addition, an area of an object may be limited to a certain range in a similar manner to ordinary video data or need not be limited in a similar manner to map data. Furthermore, a density of points or faces may be set in various ways. Sparse point cloud data or sparse mesh data may be used or dense point cloud data or dense mesh data may be used.

Next, encoding and decoding of a point cloud or a three-dimensional mesh will be described. A device, processing, or a syntax for encoding and decoding vertex information of a three-dimensional mesh according to the present disclosure may be applied to the encoding and decoding of a point cloud. A device, processing, or a syntax for encoding and decoding a point cloud according to the present disclosure may be applied to the encoding and decoding of vertex information of a three-dimensional mesh.

In addition, a device, processing, or a syntax for encoding and decoding attribute information of a point cloud according to the present disclosure may be applied to the encoding and decoding of connection information or attribute information of a three-dimensional mesh. Furthermore, a device, processing, or a syntax for encoding and decoding connection information or attribute information of a three-dimensional mesh according to the present disclosure may be applied to the encoding and decoding of attribute information of a point cloud.

Furthermore, at least a part of processing may be commonalized between the encoding and decoding of point cloud data and the encoding and decoding of mesh data. Accordingly, sizes of circuits and software programs can be suppressed.

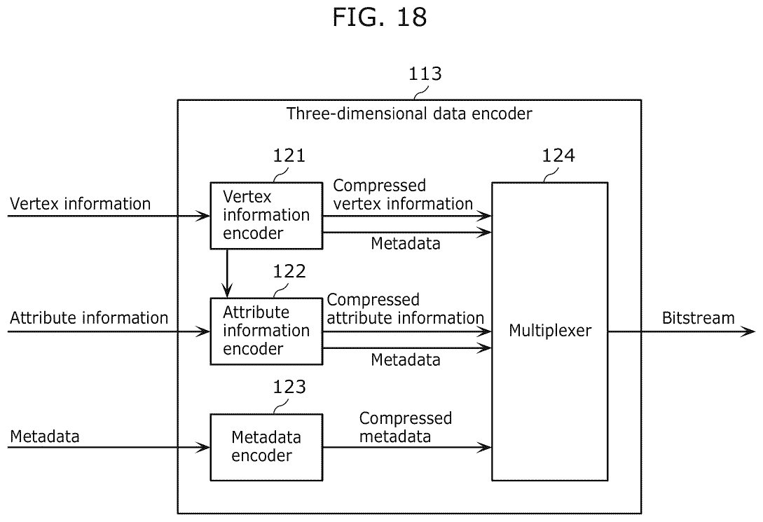

FIG. 18 is a block diagram illustrating a configuration example of three-dimensional data encoder 113 according to the present embodiment. In this example, three-dimensional data encoder 113 includes vertex information encoder 121, attribute information encoder 122, metadata encoder 123, and multiplexer 124. Vertex information encoder 121, attribute information encoder 122, and multiplexer 124 may correspond to vertex information encoder 101, attribute information encoder 103, postprocessor 105, and the like illustrated in FIG. 6.

In addition, in this example, three-dimensional data encoder 113 encodes three-dimensional data according to a geometry-based encoding system. Encoding according to the geometry-based encoding system takes a three-dimensional structure into consideration. Furthermore, in encoding according to the geometry-based encoding system, attribute information is encoded using configuration information obtained during encoding of vertex information.

Specifically, first, vertex information, attribute information, and metadata included in three-dimensional data generated from sensor data are respectively input to vertex information encoder 121, attribute information encoder 122, and metadata encoder 123. In this case, connection information included in three-dimensional data may be handled in a similar manner to attribute information. In addition, in the case of point cloud data, position information may be handled as vertex information.

Vertex information encoder 121 encodes vertex information into compressed vertex information and outputs the compressed vertex information to multiplexer 124 as encoded data. In addition, vertex information encoder 121 generates metadata of the compressed vertex information and outputs the metadata to multiplexer 124. Furthermore, vertex information encoder 121 generates configuration information and outputs the configuration information to attribute information encoder 122.

Attribute information encoder 122 encodes attribute information into compressed attribute information using the configuration information generated by vertex information encoder 121 and outputs the compressed attribute information to multiplexer 124 as encoded data. In addition, attribute information encoder 122 generates metadata of the compressed attribute information and outputs the metadata to multiplexer 124.

Metadata encoder 123 encodes compressible metadata into compressed metadata and outputs the compressed metadata to multiplexer 124 as encoded data. The metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

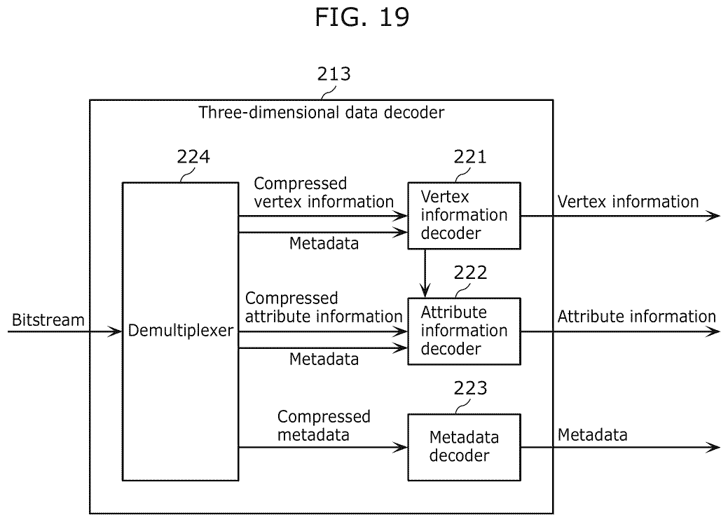

FIG. 19 is a block diagram illustrating a configuration example of three-dimensional data decoder 213 according to the present embodiment. In this example, three-dimensional data decoder 213 includes vertex information decoder 221, attribute information decoder 222, metadata decoder 223, and demultiplexer 224. Vertex information decoder 221, attribute information decoder 222, and demultiplexer 224 may correspond to vertex information decoder 201, attribute information decoder 203, preprocessor 204, and the like illustrated in FIG. 8.

In addition, in this example, three-dimensional data decoder 213 decodes three-dimensional data according to a geometry-based encoding system. Decoding according to the geometry-based encoding system takes a three-dimensional structure into consideration. Furthermore, in decoding according to the geometry-based encoding system, attribute information is decoded using configuration information obtained during decoding of vertex information.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information and the metadata of the compressed vertex information are input to vertex information decoder 221. The compressed attribute information and the metadata of the compressed attribute information are input to attribute information decoder 222. The metadata is input to metadata decoder 223.

Vertex information decoder 221 decodes vertex information from the compressed vertex information using the metadata of the compressed vertex information. In addition, vertex information decoder 221 generates configuration information and outputs the configuration information to attribute information decoder 222. Attribute information decoder 222 decodes attribute information from the compressed attribute information using the configuration information generated by vertex information decoder 221 and the metadata of the compressed attribute information. Metadata decoder 223 decodes metadata from the compressed metadata. The metadata decoded by metadata decoder 223 may be used to decode vertex information and to decode attribute information.

Subsequently, the vertex information, the attribute information, and the metadata are output from three-dimensional data decoder 213 as three-dimensional data. For example, the metadata is metadata of vertex information and attribute information and can be used in an application program.

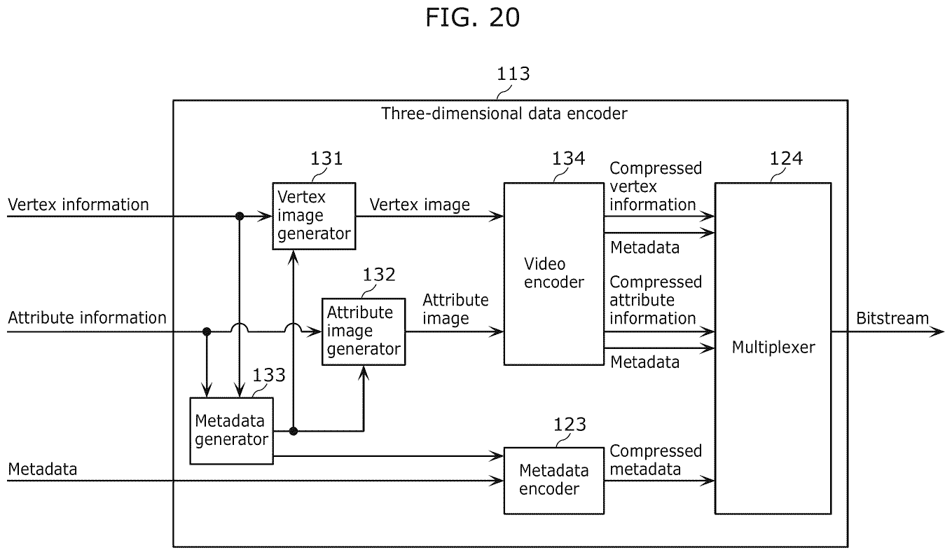

FIG. 20 is a block diagram illustrating another configuration example of three-dimensional data encoder 113 according to the present embodiment. In this example, three-dimensional data encoder 113 includes vertex image generator 131, attribute image generator 132, metadata generator 133, video encoder 134, metadata encoder 123, and multiplexer 124. Vertex image generator 131, attribute image generator 132, and video encoder 134 may correspond to vertex information encoder 101, attribute information encoder 103, and the like illustrated in FIG. 6.

In addition, in this example, three-dimensional data encoder 113 encodes three-dimensional data according to a video-based encoding system. In encoding according to the video-based encoding system, a plurality of two-dimensional images are generated from three-dimensional data and the plurality of two-dimensional images are encoded according to a video encoding system. In this case, the video encoding system may be HEVC (high efficiency video coding), VVC (versatile video coding), or the like.

Specifically, first, vertex information and attribute information included in three-dimensional data generated from sensor data are input to metadata generator 133. In addition, the vertex information and the attribute information are respectively input to vertex image generator 131 and attribute image generator 132. Furthermore, the metadata included in the three-dimensional data is input to metadata encoder 123. In this case, connection information included in three-dimensional data may be handled in a similar manner to attribute information. In addition, in the case of point cloud data, position information may be handled as vertex information.

Metadata generator 133 generates map information of a plurality of two-dimensional images from the vertex information and the attribute information. In addition, metadata generator 133 inputs the map information into vertex image generator 131, attribute image generator 132, and metadata encoder 123.

Vertex image generator 131 generates a vertex image based on the vertex information and the map information and inputs the vertex image into video encoder 134. Attribute image generator 132 generates an attribute image based on the attribute information and the map information and inputs the attribute image into video encoder 134.

Video encoder 134 respectively encodes the vertex image and the attribute image into compressed vertex information and compressed attribute information according to the video encoding system and outputs the compressed vertex information and the compressed attribute information to multiplexer 124 as encoded data. In addition, video encoder 134 generates metadata of the compressed vertex information and metadata of the compressed attribute information and outputs the pieces of metadata to multiplexer 124.

Metadata encoder 123 encodes compressible metadata into compressed metadata and outputs the compressed metadata to multiplexer 124 as encoded data. Compressible metadata includes map information. In addition, the metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

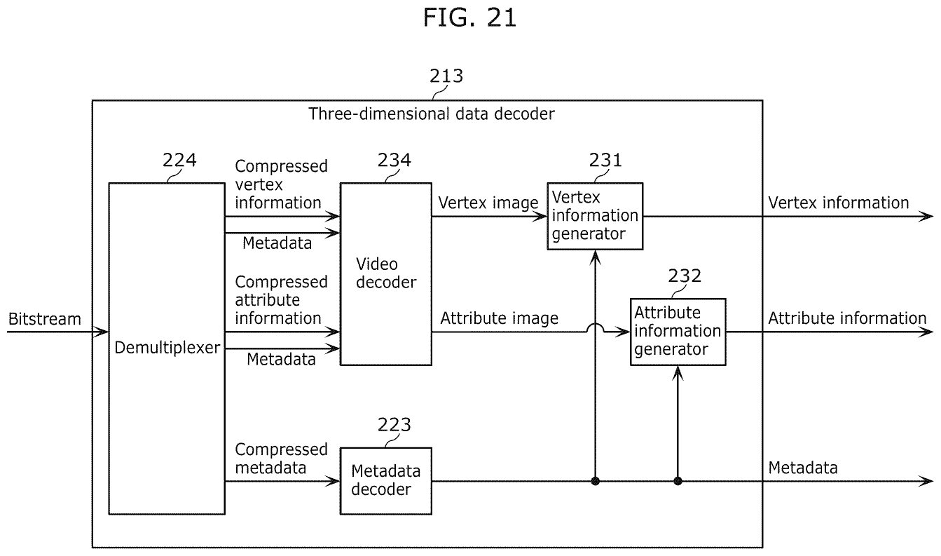

FIG. 21 is a block diagram illustrating another configuration example of three-dimensional data decoder 213 according to the present embodiment. In this example, three-dimensional data decoder 213 includes vertex information generator 231, attribute information generator 232, video decoder 234, metadata decoder 223, and demultiplexer 224. Vertex information generator 231, attribute information generator 232, and video decoder 234 may correspond to vertex information decoder 201, attribute information decoder 203, and the like illustrated in FIG. 8.

In addition, in this example, three-dimensional data decoder 213 decodes three-dimensional data according to a video-based encoding system. In decoding according to the video-based encoding system, a plurality of two-dimensional images are decoded according to a video encoding system and three-dimensional data is generated from the plurality of two-dimensional images. In this case, the video encoding system may be HEVC (high efficiency video coding), VVC (versatile video coding), or the like.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information, the metadata of the compressed vertex information, the compressed attribute information, and the metadata of the compressed attribute information are input to video decoder 234. The compressed metadata is input to metadata decoder 223.

Video decoder 234 decodes a vertex image according to the video encoding system. In doing so, video decoder 234 decodes the vertex image from the compressed vertex information using the metadata of the compressed vertex information. In addition, video decoder 234 inputs the vertex image into vertex information generator 231. Furthermore, video decoder 234 decodes an attribute image according to the video encoding system. In doing so, video decoder 234 decodes the attribute image from the compressed attribute information using the metadata of the compressed attribute information. In addition, video decoder 234 inputs the attribute image into attribute information generator 232.

Metadata decoder 223 decodes metadata from the compressed metadata. The metadata decoded by metadata decoder 223 includes map information to be used to generate vertex information and to generate attribute information. In addition, the metadata decoded by metadata decoder 223 may be used to decode the vertex image and to decode the attribute image.

Vertex information generator 231 reproduces vertex information from the vertex image according to the map information included in the metadata decoded by metadata decoder 223. Attribute information generator 232 reproduces attribute information from the attribute image according to the map information included in the metadata decoded by metadata decoder 223.

Subsequently, the vertex information, the attribute information, and the metadata are output from three-dimensional data decoder 213 as three-dimensional data. For example, the metadata is metadata of vertex information and attribute information and can be used in an application program.

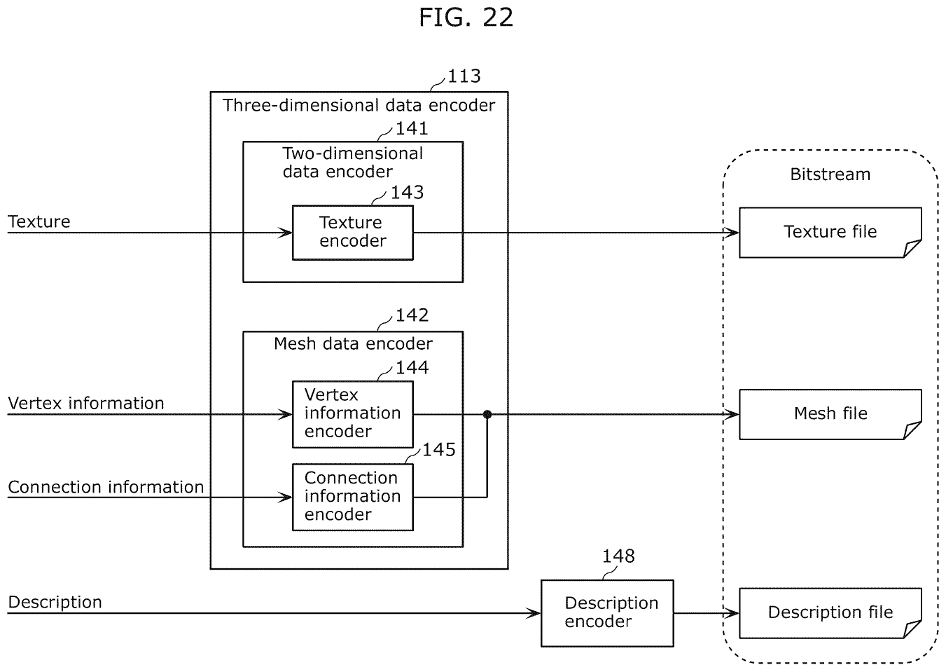

FIG. 22 is a conceptual diagram illustrating a specific example of encoding processing according to the present embodiment. FIG. 22 illustrates three-dimensional data encoder 113 and description encoder 148. In this example, three-dimensional data encoder 113 includes two-dimensional data encoder 141 and mesh data encoder 142. Two-dimensional data encoder 141 includes texture encoder 143. Mesh data encoder 142 includes vertex information encoder 144 and connection information encoder 145.

Vertex information encoder 144, connection information encoder 145, and texture encoder 143 may correspond to vertex information encoder 101, connection information encoder 102, attribute information encoder 103, and the like illustrated in FIG. 6.

For example, two-dimensional data encoder 141 operates as texture encoder 143 and generates a texture file by encoding a texture corresponding to attribute information as two-dimensional data according to an image encoding system or a video encoding system.

In addition, mesh data encoder 142 operates as vertex information encoder 144 and connection information encoder 145 and generates a mesh file by encoding vertex information and connection information. Mesh data encoder 142 may further encode mapping information with respect to a texture. The encoded mapping information may be included in a mesh file.

In addition, description encoder 148 generates a description file by encoding a description corresponding to metadata such as text data. Description encoder 148 may encode a description in the system layer. For example, description encoder 148 may be included in system multiplexer 114 illustrated in FIG. 12.

Due to the operation described above, a bitstream including a texture file, a mesh file, and a description file is generated. The files may be multiplexed in the bitstream in a file format such as gITF (graphics language transmission format) or USD (universal scene description).

Note that three-dimensional data encoder 113 may include two mesh data encoders as mesh data encoder 142. For example, one mesh data encoder encodes vertex information and connection information of a static three-dimensional mesh and the other mesh data encoder encodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

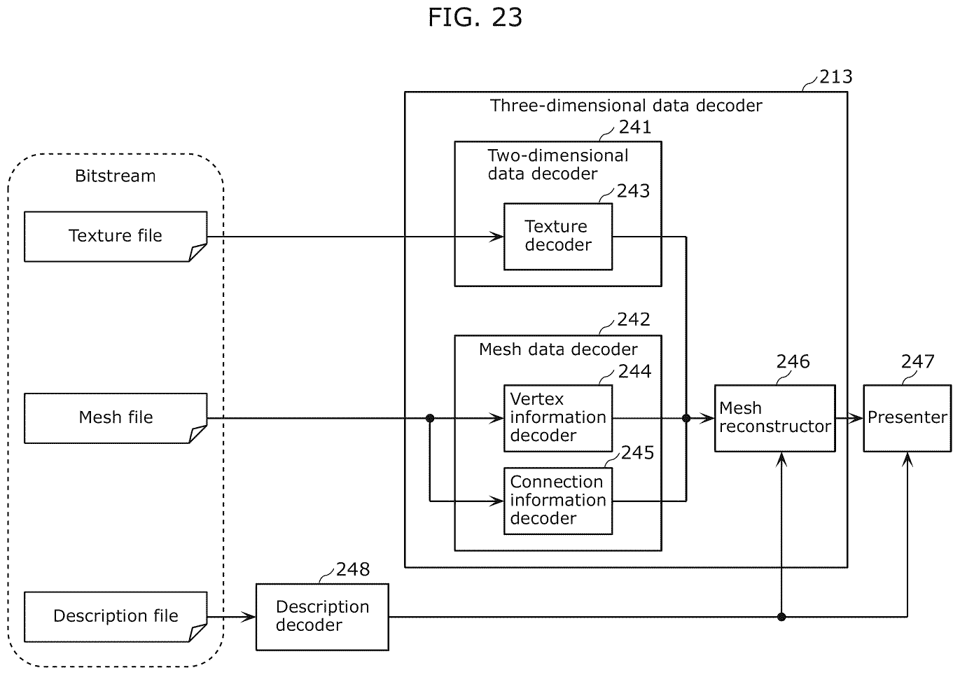

FIG. 23 is a conceptual diagram illustrating a specific example of decoding processing according to the present embodiment. FIG. 23 illustrates three-dimensional data decoder 213, description decoder 248, and presenter 247. In this example, three-dimensional data decoder 213 includes two-dimensional data decoder 241, mesh data decoder 242, and mesh reconstructor 246. Two-dimensional data decoder 241 includes texture decoder 243. Mesh data decoder 242 includes vertex information decoder 244 and connection information decoder 245.

Vertex information decoder 244, connection information decoder 245, texture decoder 243, and mesh reconstructor 246 may correspond to vertex information decoder 201, connection information decoder 202, attribute information decoder 203, postprocessor 205, and the like illustrated in FIG. 8. Presenter 247 may correspond to presenter 215 and the like illustrated in FIG. 12.

For example, two-dimensional data decoder 241 operates as texture decoder 243 and decodes a texture corresponding to attribute information from a texture file as two-dimensional data according to an image encoding system or a video encoding system.

In addition, mesh data decoder 242 operates as vertex information decoder 244 and connection information decoder 245 and decodes vertex information and connection information from a mesh file. Mesh data decoder 242 may further decode mapping information with respect to a texture from the mesh file.

Furthermore, description decoder 248 decodes a description corresponding to metadata such as text data from a description file. Description decoder 248 may decode a description in the system layer. For example, description decoder 248 may be included in system demultiplexer 214 illustrated in FIG. 12.

Mesh reconstructor 246 reconstructs a three-dimensional mesh from vertex information, connection information, and a texture according to a description. Presenter 247 renders and outputs the three-dimensional mesh according to the description.

Due to the operation described above, a three-dimensional mesh is reconstructed and output from a bitstream including a texture file, a mesh file, and a description file.

Note that three-dimensional data decoder 213 may include two mesh data decoders as mesh data decoder 242. For example, one mesh data decoder decodes vertex information and connection information of a static three-dimensional mesh and the other mesh data decoder decodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

An encoding system of a dynamic three-dimensional mesh may be called DMC (dynamic mesh coding). In addition, a video-based encoding system of a dynamic three-dimensional mesh may be called VDMC (video-based dynamic mesh coding).

An encoding system of a point cloud may be called PCC (point cloud compression). A video-based encoding system of a point cloud may be called V-PCC (video-based point cloud compression). In addition, a geometry-based encoding system of a point cloud may be called G-PCC (geometry-based point cloud compression).

### Implementation Example

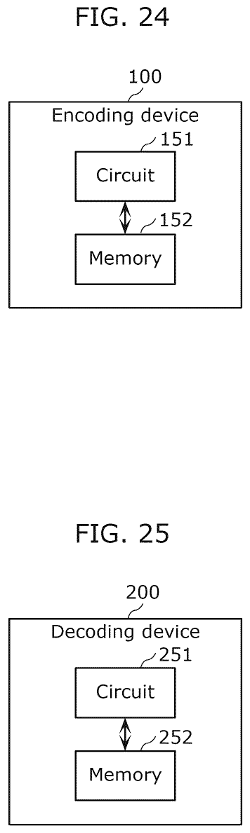

FIG. 24 is a block diagram illustrating an implementation example of encoding device 100 according to the present embodiment. Encoding device 100 includes circuit 151 and memory 152. For example, a plurality of constituent elements of encoding device 100 illustrated in FIG. 5 and the like are implemented by circuit 151 and memory 152 illustrated in FIG. 24.

Circuit 151 is a circuit which performs information processing and which is capable of accessing memory 152. For example, circuit 151 is a dedicated or general-purpose electric circuit which encodes a three-dimensional mesh. Circuit 151 may be a processor such as a CPU. Alternatively, circuit 151 may be a set of a plurality of electric circuits.

Memory 152 is a dedicated or general-purpose memory that stores information used by circuit 151 to encode a three-dimensional mesh. Memory 152 may be an electric circuit and may be connected to circuit 151. In addition, memory 152 may be included in circuit 151. Alternatively, memory 152 may be a set of a plurality of electric circuits. Furthermore, memory 152 may be a magnetic disk, an optical disk, or the like or may be expressed as a storage, a recording medium, or the like. In addition, memory 152 may be a non-volatile memory or a volatile memory.

For example, memory 152 may store a three-dimensional mesh or a bitstream. In addition, memory 152 may store a program used by circuit 151 to encode a three-dimensional mesh.

Note that in encoding device 100, all of the plurality of constituent elements illustrated in FIG. 5 and the like need not be implemented and all of the plurality of processing steps described herein need not be performed. A part of the plurality of constituent elements illustrated in FIG. 5 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in encoding device 100.

FIG. 25 is a block diagram illustrating an implementation example of decoding device 200 according to the present embodiment. Decoding device 200 includes circuit 251 and memory 252. For example, a plurality of constituent elements of decoding device 200 illustrated in FIG. 7 and the like are implemented by circuit 251 and memory 252 illustrated in FIG. 25.

Circuit 251 is a circuit which performs information processing and which is capable of accessing memory 252. For example, circuit 251 is a dedicated or general-purpose electric circuit which decodes a three-dimensional mesh. Circuit 251 may be a processor such as a CPU. Alternatively, circuit 251 may be a set of a plurality of electric circuits.

Memory 252 is a dedicated or general-purpose memory that stores information used by circuit 251 to decode a three-dimensional mesh. Memory 252 may be an electric circuit and may be connected to circuit 251. In addition, memory 252 may be included in circuit 251. Alternatively, memory 252 may be a set of a plurality of electric circuits. Furthermore, memory 252 may be a magnetic disk, an optical disk, or the like or may be expressed as a storage, a recording medium, or the like. In addition, memory 252 may be a non-volatile memory or a volatile memory.

For example, memory 252 may store a three-dimensional mesh or a bitstream. In addition, memory 252 may store a program used by circuit 251 to decode a three-dimensional mesh.

Note that in decoding device 200, all of the plurality of constituent elements illustrated in FIG. 7 and the like need not be implemented and all of the plurality of processing steps described herein need not be performed. A part of the plurality of constituent elements illustrated in FIG. 7 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in decoding device 200.

An encoding method and a decoding method including steps performed by each constituent element of encoding device 100 and decoding device 200 according to the present disclosure may be executed by any device or system. For example, a part of or all of the encoding method and the decoding method may be executed by a computer including a processor, a memory, an input/output circuit, and the like. In doing so, the encoding method and the decoding method may be executed by having the computer execute a program that enables the computer to execute the encoding method and the decoding method.

In addition, a program or a bitstream may be recorded on a non-transitory computer-readable recording medium such as a CD-ROM.

An example of a program may be a bitstream. For example, a bitstream including an encoded three-dimensional mesh includes a syntax element that enables decoding device 200 to decode the three-dimensional mesh. In addition, the bitstream causes decoding device 200 to decode the three-dimensional mesh according to the syntax element included in the bitstream. Therefore, a bitstream can perform a similar role to a program.

The bitstream described above may be an encoded bitstream including an encoded three-dimensional mesh or a multiplexed bitstream including an encoded three-dimensional mesh and other information.

In addition, each constituent element of encoding device 100 and decoding device 200 may be constituted of dedicated hardware, general-purpose hardware which executes the program or the like described above, or a combination thereof. Furthermore, the general-purpose hardware may be constituted of a memory on which a program is recorded, a general-purpose processor which reads the program from the memory and executes the program, and the like. In this case, the memory may be a semiconductor memory, a hard disk, or the like and the general-purpose processor may be a CPU or the like.

Furthermore, the dedicated hardware may be constituted of a memory, a dedicated processor, and the like. For example, the dedicated processor may execute the encoding method and the decoding method by referring to a memory for recording data.

In addition, as described above, the respective constituent elements of encoding device 100 and decoding device 200 may be electric circuits. The electric circuits may constitute one electric circuit as a whole or may be respectively different electric circuits. Furthermore, the electric circuits may correspond to dedicated hardware or to general-purpose hardware which executes the program or the like described above. Moreover, encoding device 100 and decoding device 200 may be implemented as integrated circuits.

In addition, encoding device 100 may be a transmitting device which transmits a three-dimensional mesh. Decoding device 200 may be a receiving device which receives a three-dimensional mesh.

### <Encoding and Decoding of Vertex Information>

A three-dimensional model digitally represents an object in such a manner that a user can search the model through zooming, panning, and rotation in all of the three dimensions while temporarily rendering the model. One method of constructing such a representation is to construct a three-dimensional mesh with triangles. The model stores positions of vertexes of triangles, connectivity of the vertexes, and attributes associated with the vertexes (such as normal and UV patches). To store all of these items of information in an uncompressed manner, a vast storage area is needed, and therefore, the bandwidth for transmission substantially increases.

Triangles forming a mesh, in particular, those in temporal or spatial proximity to each other, often have repetitive patterns and similar attributes. Such a repetition can be used for planning efficient encoding method and decoding method for storage and transmission.

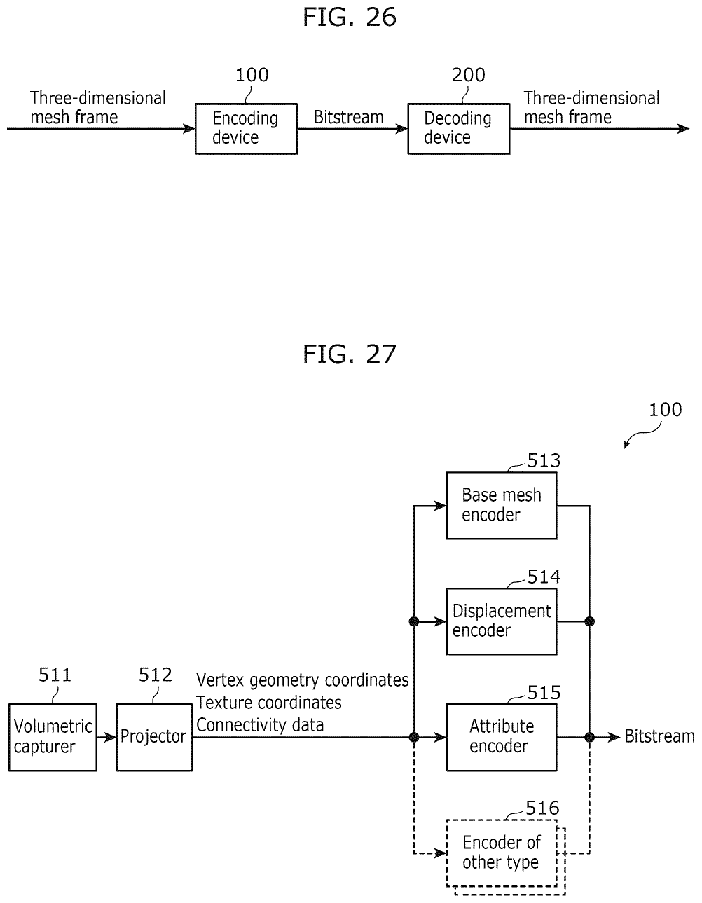

FIG. 26 is a block diagram illustrating an architecture of an encoding/decoding system according to the embodiment. As illustrated in FIG. 26, the architecture of the encoding/decoding system includes encoding device 100 and decoding device 200. The encoding/decoding system receives an input three-dimensional mesh frame in forms of vertex geometry coordinates (vertex information), texture coordinates (attribute information), and connectivity data (connection information).

Encoding device 100 is responsible for encoding all associated information into a bitstream (compressed bitstream). The bitstream may be formed by a plurality of bitstreams. The bitstream is transmitted to decoding device 200 through a transmission path. decoding device 200 decodes the bitstream and generates a three-dimensional mesh frame from the decoded vertex geometry coordinates, texture coordinates, and connectivity data.

FIG. 27 is a block diagram illustrating an example of an architecture of encoding device 100 according to the embodiment. In this example, encoding device 100 includes volumetric capturer 511, projector 512, base mesh encoder 513, displacement encoder 514, attribute encoder 515, and one or more optional encoders 516 of another type.

Volumetric capturer 511 captures a content and passes the content to projector 512. Projector 512 projects the content onto an input mesh including vertex geometry coordinates, texture coordinates, and connectivity data. This data is then sent to base mesh encoder 513, displacement encoder 514, attribute encoder 515, and one or more optional encoders 516 of another type. These encoders compress the data into a bitstream.

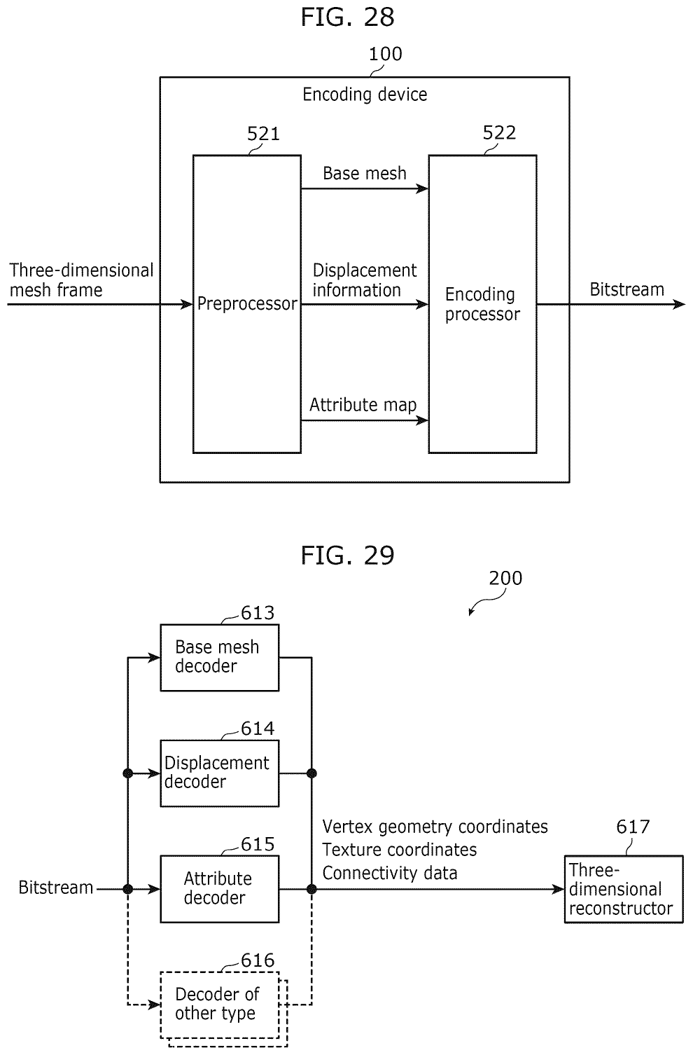

FIG. 28 is a block diagram illustrating another example of the architecture of encoding device 100 according to the embodiment. In this example, encoding device 100 includes preprocessor 521 and encoding processor 522.

Preprocessor 521 reads a three-dimensional mesh frame, extracts a base mesh, displacement information, and an attribute map, and passes the base mesh, displacement information, and attribute map to encoding processor 522. An example of the displacement information is a displacement vector. Encoding processor 522 separately compresses the base mesh, the displacement information, and the attribute map, and combines them to generate a bitstream.

FIG. 29 is a block diagram illustrating an example of an architecture of decoding device 200 according to the embodiment. In this example, decoding device 200 includes base mesh decoder 613, displacement decoder 614, attribute decoder 615, one or more decoders 616 of another type, and three-dimensional reconstructor 617.

The bitstream is sent to base mesh decoder 613, displacement decoder 614, attribute decoder 615, and one or more optional decoders 616 of another type. These decoders decode the bitstream to generate decoded data including vertex geometry coordinates, texture coordinates, and connectivity data. The decoded data is then sent to three-dimensional reconstructor 617, which reconstructs the three-dimensional mesh frame.

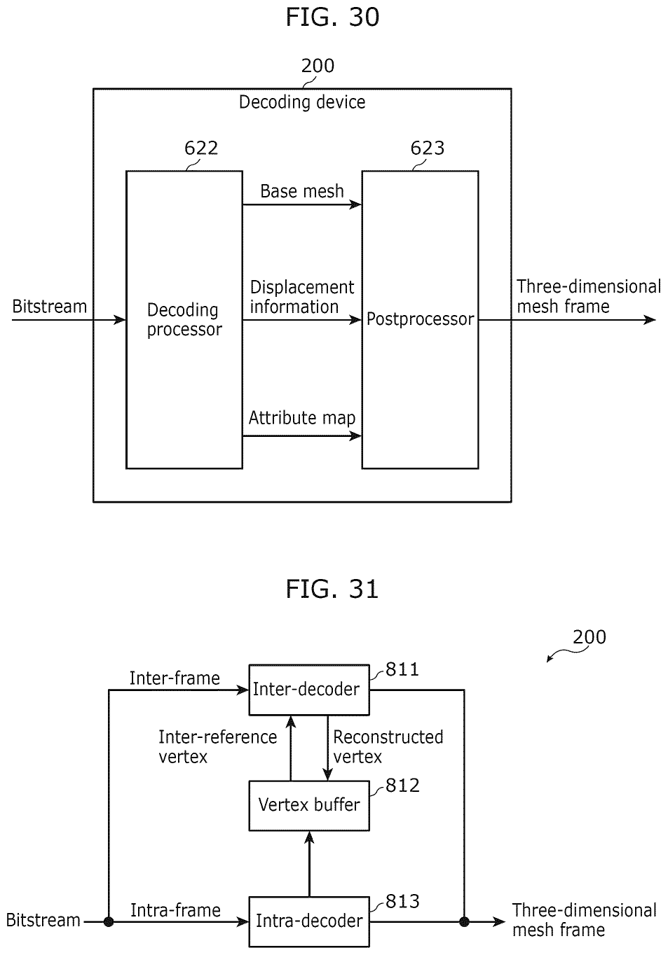

FIG. 30 is a block diagram illustrating another example of the architecture of decoding device 200 according to the embodiment. In this example, decoding device 200 includes decoding processor 622 and postprocessor 623.

Decoding processor 622 first reads the bitstream, separates the base mesh, the displacement information, and the attribute map from the compressed bitstream, separately decodes them, and passes them to postprocessor 623. An example of the displacement information is a displacement vector. Postprocessor 623 processes the base mesh according to the displacement information and the attribute map to generate the three-dimensional mesh frame.

FIG. 31 is a block diagram illustrating another example of the architecture of decoding device 200 according to the embodiment. This drawing particularly illustrates an architecture associated with the vertex information. In this example, decoding device 200 includes inter-decoder 811, vertex buffer 812, and intra-decoder 813.

When a current frame to be processed is an interframe, inter-decoder 811 decodes a current vertex to be processed in the current frame by referring to an inter-reference vertex in vertex buffer 812.

Here, the interframe is a frame a vertex of which is processed by referring to a vertex of a processed frame. The vertex processed by referring to a vertex of a processed frame may be referred to also as an inter-vertex. The frame referred to in this case may be referred to also as a reference frame or an inter-reference frame. The vertex referred to in this case may be referred to also as a reference vertex or an inter-reference vertex.

For example, inter-decoder 811 generates an inter-predicted vertex using an inter-reference vertex. The inter-predicted vertex may be the inter-reference vertex itself. Inter-decoder 811 then decodes the difference between the inter-predicted vertex and the current vertex and adds the difference to the inter-predicted vertex, thereby decoding (reconstructing) the current vertex.

The current vertex decoded (reconstructed) by inter-decoder 811 is stored in vertex buffer 812 as a reconstructed vertex. The reconstructed vertex stored in vertex buffer 812 can be referred to, as an inter-reference vertex, in decoding of another vertex, for example. Furthermore, the current vertex decoded by inter-decoder 811 forms the three-dimensional mesh frame to be output.

When a current frame to be processed is an intraframe, intra-decoder 813 decodes a current vertex to be processed in the current frame by referring to an intra-reference vertex in the current frame.

For example, intra-decoder 813 generates an intra-predicted vertex using an intra-reference vertex. The intra-predicted vertex may be the intra-reference vertex itself. Intra-decoder 813 then decodes the difference between the intra-predicted vertex and the current vertex and adds the difference to the intra-predicted vertex, thereby decoding (reconstructing) the current vertex.

The current vertex decoded (reconstructed) by intra-decoder 813 is stored in vertex buffer 812 as a reconstructed vertex. The reconstructed vertex stored in vertex buffer 812 can be referred to, as an inter-reference vertex, in decoding of another vertex, for example. Furthermore, the current vertex decoded by intra-decoder 813 forms the three-dimensional mesh frame to be output.

Note that inter-decoder 811 and intra-decoder 813 may be able to decode the current vertex without referring to another vertex. That is, inter-decoder 811 and intra-decoder 813 may decode the current vertex itself rather than the difference. The operation in such a case corresponds to an operation of decoding the difference and adding the difference to the reference vertex on the assumption that the reference vertex is (0, 0, 0).

Decoding device 200 may further include a frame header decoder that decodes a frame header of each frame. The frame header may indicate whether the frame is an interframe or an intraframe.

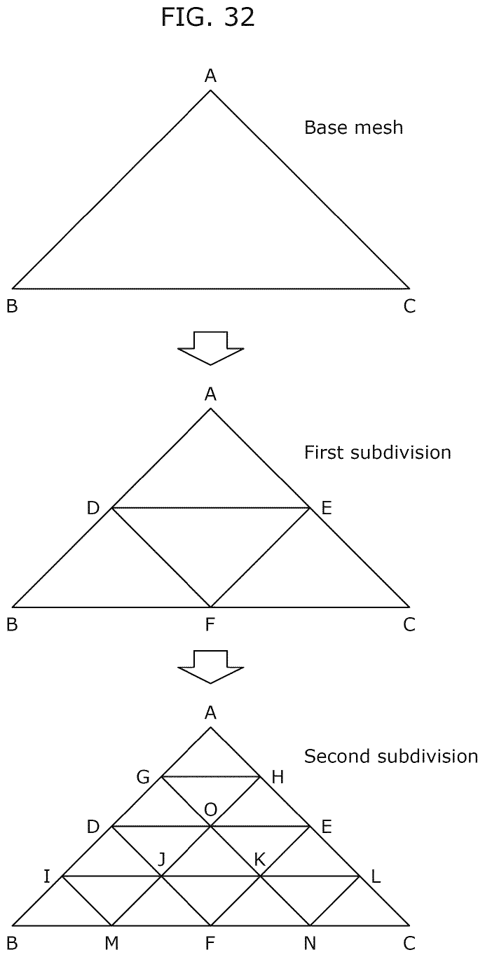

FIG. 32 is a conceptual diagram illustrating an example of subdivision according to the embodiment. For example, the base mesh includes vertexes A, B, and C and connectivity thereof.

In first subdivision, new vertexes D, E, and F are added between already connected vertexes A and B, B and C, and C and A, respectively, and connectivity thereof is added. The added new vertexes and the connectivity thereof form a first level along with the existing vertexes and connectivity. In second subdivision, a similar process is repeated, and vertexes G, H, I, J, K, L, M, N, and O and connectivity thereof are added to form a second level.

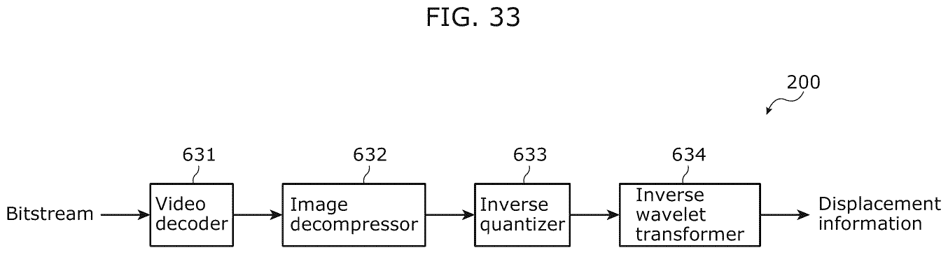

FIG. 33 is a block diagram illustrating another example of the architecture of decoding device 200 according to the embodiment. This drawing particularly illustrates an architecture associated with displacement information. In this example, decoding device 200 includes video decoder 631, image decompressor 632, inverse quantizer 633, and inverse wavelet transformer 634.

Video decoder 631 reads a bitstream and decodes data of the image in a video frame expansion method on the assumption that the image of the bitstream is an image having two items of chrominance information and one item of luminance information. Image decompressor 632 extracts a wavelet coefficient associated with each vertex from the expanded data in the image format. Inverse quantizer 633 then performs inverse quantization of the quantized wavelet coefficients for three components associated with each vertex. Inverse wavelet transformer 634 performs inverse transformation of the result to obtain final displacement information.

An example of the displacement information is a displacement vector. The displacement information is used for displacement of a vertex in the three-dimensional mesh frame.

In the following, concerning encoding processing and decoding processing for the vertex information, an arrangement and a method for achieving more excellent compression based on a temporal redundancy and a spatial redundancy will be shown.

### <Encoding Processing for Vertex Information>

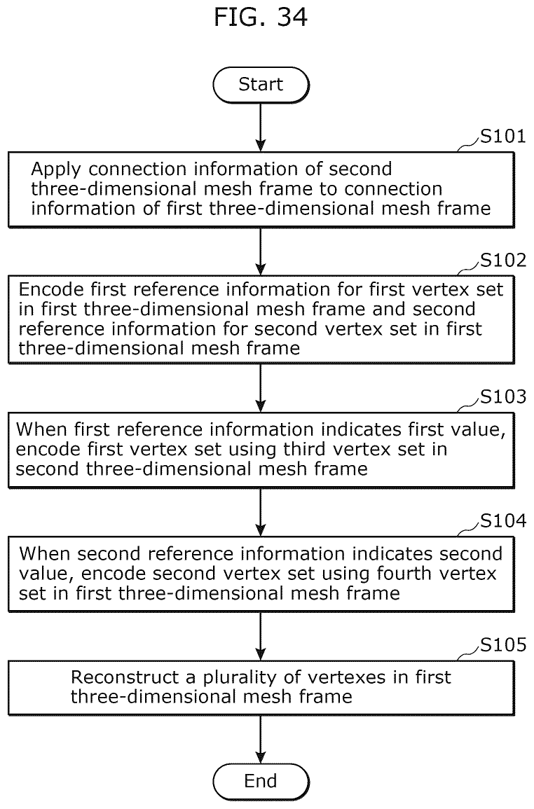

FIG. 34 is a flowchart illustrating mesh encoding processing according to the embodiment. In this example, first, connection information of a second three-dimensional mesh frame is applied to connection information of a first three-dimensional mesh frame (S101). Then, first reference information for a first vertex set in the first three-dimensional mesh frame and second reference information for a second vertex set in the first three-dimensional mesh frame are encoded into a bitstream (S102). An example of the first three-dimensional mesh frame is a current three-dimensional mesh frame to be encoded.

Each item of reference information may be represented by one or more reference parameters. An example of the reference parameter is an index of an identifier of the three-dimensional mesh frame. An example of the index is a numeric value, such as 0, 1, 2, and 3. Another example of the index is an alphabet, such as A, B, and C. Another example of the index is a Roman numeral, such as I, II, and III.

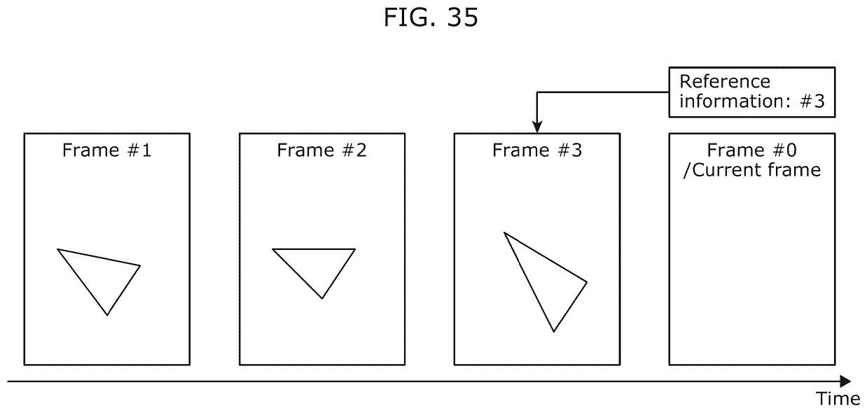

FIG. 35 is a conceptual diagram illustrating an example of the reference information according to the embodiment. In this example, the reference information is represented by a number that is an index of the identifier of the three-dimensional mesh frame. Specifically, the reference information is represented by “#3”. That is, in this example, the reference information indicates frame #3 among a plurality of frames #0 to #3. In another example, the reference information may indicate the current frame itself.

In the example in FIG. 34, when the first reference information indicates a first value, the first vertex set is encoded using a third vertex set in the second three-dimensional mesh frame (S103). Here, the three-dimensional mesh frame is a second three-dimensional mesh frame that is temporally different from the first three-dimensional mesh frame. An example of the second three-dimensional mesh frame is a three-dimensional mesh frame that is previously encoded.

An example of the third vertex set is all vertexes in a three-dimensional region. An example of the three-dimensional region is a rectangular parallelepiped defined by a height, a width, and a depth with respect to a reference point.

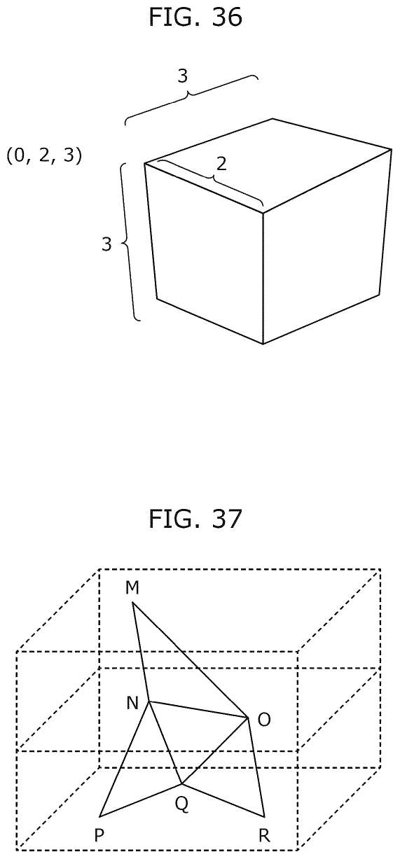

FIG. 36 is a conceptual diagram illustrating an example of the three-dimensional region according to the embodiment. In the example in FIG. 36, the three-dimensional region is a rectangular parallelepiped defined by a height of 3, a width of 2, and a depth of 3 with respect to a reference point (0, 2, 3). In another example, the three-dimensional area is a sphere defined by coordinates of the center and a radius. In another example, the three-dimensional region is a cube defined by coordinates of the vertexes and a length of the sides.

FIG. 37 is a conceptual diagram illustrating an example of a vertex set located inside a rectangular parallelepiped according to the embodiment. In this example, some of vertexes M, N, O, P, Q, and R of a three-dimensional mesh can be selected as a third vertex set because those vertexes are located inside a rectangular parallelepiped. For example, the third vertex set is formed by the vertexes in the upper rectangular parallelepiped, that is, the vertexes M, N, and O. In another example, the third vertex set is formed by the vertexes in the lower rectangular parallelepiped, that is, the vertexes P, Q, and R.

For example, the third vertex set is selected and used as a predicted vertex set for a first vertex set. An example of encoding of the first vertex set using the third vertex set is encoding of the difference between the third vertex set and the first vertex set. Specifically, the differences between corresponding vertexes in the third vertex set and the first vertex set are encoded. Furthermore, in the encoding of a plurality of differences, a difference between differences may be encoded.

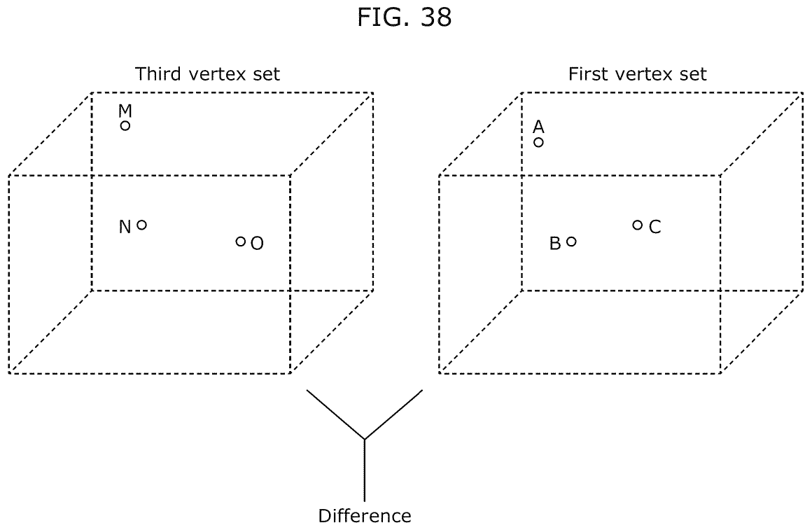

FIG. 38 is a conceptual diagram illustrating a relationship between the first vertex set, the third vertex set, and the difference therebetween according to the embodiment. Here, the third vertex set includes vertexes M (10, 8, 5), N (14, 3, 3), and O (12, 2, 2). The first vertex set includes vertexes A (12, 9, 8), B (17, 4, 4), and C (13, 2, 3). The differences between the vertexes are calculated as (2, 1, 3), (3, 1, 1), and (1, 0, 1).

These differences may be encoded. Alternatively, differences between the differences may be encoded. That is, (2, 1, 3) may be encoded, the difference (1, 0, −2) between (2, 1, 3) and (3, 1, 1) may be encoded, and the difference (−2, 1, 0) between (3, 1, 1) and (1, 0, 1) may be encoded.

In the example in FIG. 34, when the second reference information indicates a second value, the second vertex set is encoded using a fourth vertex set in the first three-dimensional mesh frame (S104).

An example of the encoding of the second vertex set using the fourth vertex set is encoding of the difference between a vertex in the fourth vertex set and a vertex in the second vertex set.

For example, the fourth vertex set includes one vertex. In encoding of the first vertex from the top in the second vertex set, the difference between the one vertex in the fourth vertex set and the first vertex from the top in the second vertex set is encoded. In encoding of the second vertex from the top in the second vertex set, the difference between the first vertex from the top in the second vertex set and the second vertex from the top in the second vertex set is encoded.

Furthermore, in encoding of the third vertex from the top in the second vertex set, the difference between the second vertex from the top in the second vertex set and the third vertex from the top in the second vertex set is encoded. Such encoding of the difference may be repeated. Note that the order of encoding of vertexes may correspond to the order of scanning of vertexes.

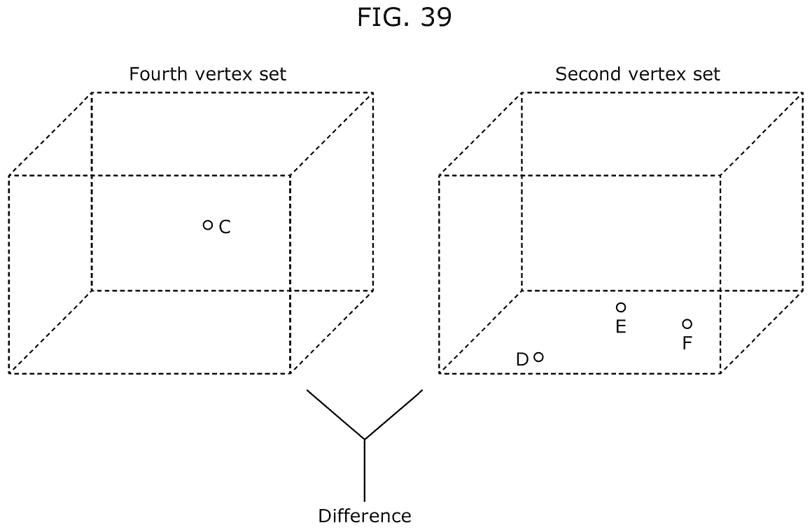

FIG. 39 is a conceptual diagram illustrating a relationship between the second vertex set, the fourth vertex set, and the difference therebetween according to the embodiment. Here, the fourth vertex set includes a vertex C (13, 2, 3). The second vertex set includes vertexes D (15, 1, 2), E (19, 0, 0), and F (12, 1, 0).

In encoding of the vertex D, the difference (2, −1, −1) between the vertexes C and D may be encoded. Furthermore, in encoding of the vertex E, the difference (4, −1, −2) between the vertexes D and E may be encoded. in encoding of the vertex F, the difference (−7, 1, 0) between the vertexes E and F may be encoded.

Note that the fourth vertex set may be regarded as partially overlapping with the second vertex set and including the vertexes C, D, and E. In that case, in encoding of the vertex D in the second vertex set, the difference between the vertexes C and D may be encoded. In encoding of the vertex E in the second vertex set, the difference between the vertexes D and E may be encoded. In encoding of the vertex F in the second vertex set, the difference between the vertexes E and F may be encoded.

Furthermore, the difference between the vertexes D and E corresponds to the difference between the difference between the vertexes C and D and the difference between the vertexes C and E. That is, the difference between the vertexes D and E can be regarded as a difference between differences.

FIG. 39 illustrates an example in which the coordinates of the vertexes D, E, and F forming the current frame are encoded using the coordinates of the vertex C that belongs to the current frame and is already encoded. In this example, the encoded vertex C is one of the vertexes that form the same object as the object formed by the vertexes D, E, and F to be encoded and may be a vertex encoded immediately before the vertexes D, E, and F to be encoded in the encoding order. However, the reference vertex is not limited to this example.

For example, three vertexes D, E, and F to be encoded may be encoded by referring to three encoded vertexes, respectively. In that case, the three encoded vertexes may be vertexes prediction-encoded immediately before the three vertexes to be encoded in the encoding order.

Alternatively, for example, an encoded vertex set may be specified by an encoding parameter. The encoded vertex set may belong to the same frame as the frame to be encoded. The encoded vertex set may belong to the same object as the vertexes to be encoded or belong to a different object.

In the example in FIG. 34, then, a plurality of vertexes in the first three-dimensional mesh frame are reconstructed (S105). In this process, the first vertex set and the second vertex set are reconstructed. Specifically, when the first vertex set is encoded using the third vertex set, the first vertex set is reconstructed using the third vertex set and the encoded first vertex set. When the second vertex set is encoded using the fourth vertex set, the second vertex set is reconstructed using the fourth vertex set and the encoded second vertex set.

For example, when the difference between the first vertex set and the third vertex set is encoded, the first vertex set may be reconstructed by adding the difference to the third vertex set. When the difference between the second vertex set and the fourth vertex set is encoded, the second vertex set may be reconstructed by adding the difference to the fourth vertex set. In this way, a plurality of vertexes in the first three-dimensional mesh frame are reconstructed.

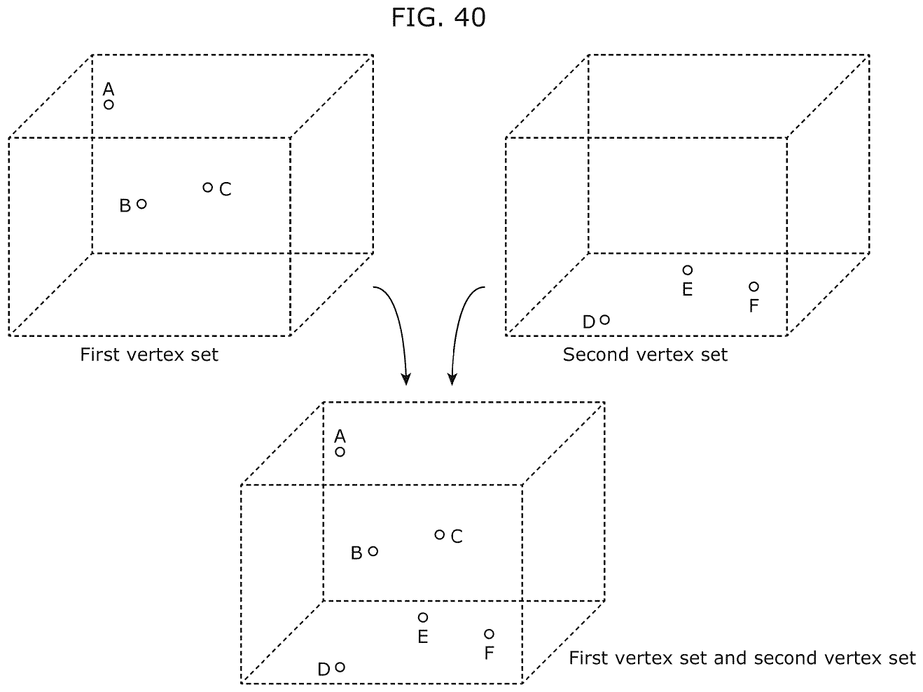

FIG. 40 is a conceptual diagram illustrating an example in which a plurality of vertexes in the first three-dimensional mesh frame are reconstructed according to the embodiment. In this example, a plurality of vertexes in the first three-dimensional mesh frame are reconstructed by combining the first vertex set and the second vertex set. In another example of the reconstruction of the first vertex set and the second vertex set, the plurality of vertexes in the first vertex set and the second vertex set may form a base mesh, and some of these vertexes may be displaced using a displacement vector encoded in the bitstream.

In the example in FIG. 34, first, the connection information of the second three-dimensional mesh frame is applied to the connection information of the first three-dimensional mesh frame (S101). That is, connection information of a three-dimensional mesh in the second three-dimensional mesh frame is applied to connection information of a plurality of vertexes reconstructed in the first three-dimensional mesh frame.

For example, when the first reference information indicates a first value, and at least one vertex of a triangle is included in the first vertex set, connection information of the triangle may be copied from the second three-dimensional mesh frame to the first three-dimensional mesh frame.

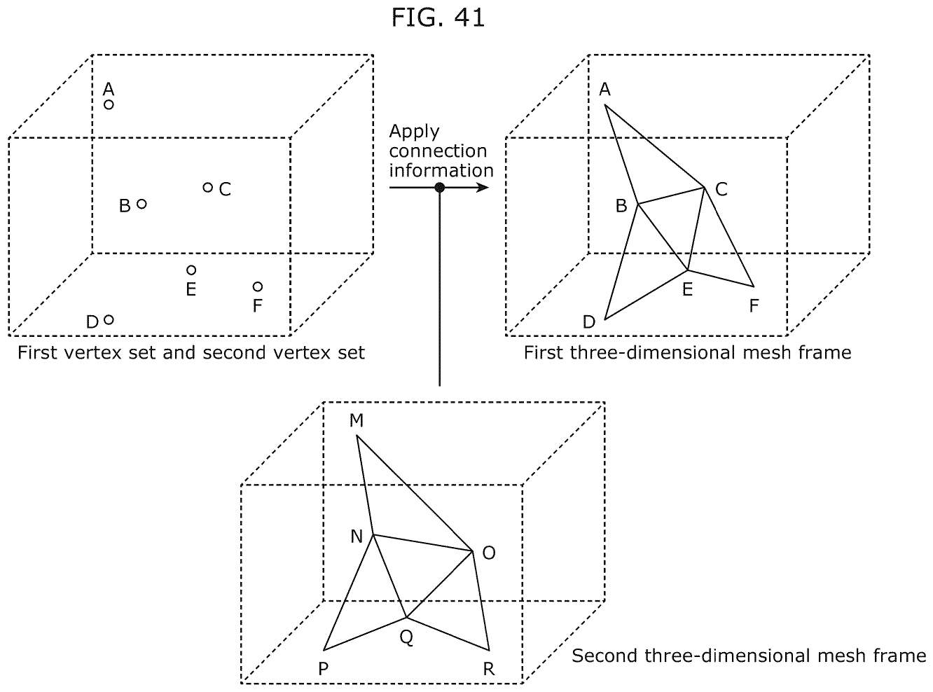

FIG. 41 is a conceptual diagram illustrating an example of the application of connection information according to the embodiment. Here, the vertexes A, B, and C are included in the first vertex set encoded using the third vertex set in the second three-dimensional mesh frame. Therefore, edges AB, BC, AC, CE, CF, BD, and BE are copied from the second three-dimensional mesh frame, and the vertexes A and B, B and C, A and C, C and E, C and F, B and D, and B and E are connected to each other. In addition, the vertexes D and E as well as E and F may be treated as being connected to each other based on the encoding order.

In this example, connection information about the first vertex set encoded using the third vertex set in the second three-dimensional mesh frame is copied from the second three-dimensional mesh frame to the first three-dimensional mesh frame. That is, connection information about a vertex set to which the inter-prediction is applied is copied from the second three-dimensional mesh frame to the first three-dimensional mesh frame.

However, connection information may be copied from the second three-dimensional mesh frame to the first three-dimensional mesh frame, regardless of whether the connection information is connection information about a vertex set to which the inter-prediction is applied. Specifically, connection information about a vertex set to which the intra-prediction is applied may be copied from the second three-dimensional mesh frame to the first three-dimensional mesh frame.

Furthermore, in this example, connection information of the second three-dimensional mesh frame is applied to reconstructed vertex information of the first three-dimensional mesh frame. However, connection information of the second three-dimensional mesh frame may not only be applied to reconstructed vertex information of the first three-dimensional mesh frame but also be used as connection information of the first three-dimensional mesh frame.

Specifically, connection information of the second three-dimensional mesh frame may be used for encoding of a plurality of vertexes of the first three-dimensional mesh frame. More specifically, connection information f the second three-dimensional mesh frame may be used in the encoding order or prediction order of a plurality of vertexes in the first three-dimensional mesh frame, may be used for determination of a reference vertex or predicted vertex, or may be used for determination of whether the prediction is inter-prediction or intra-prediction.

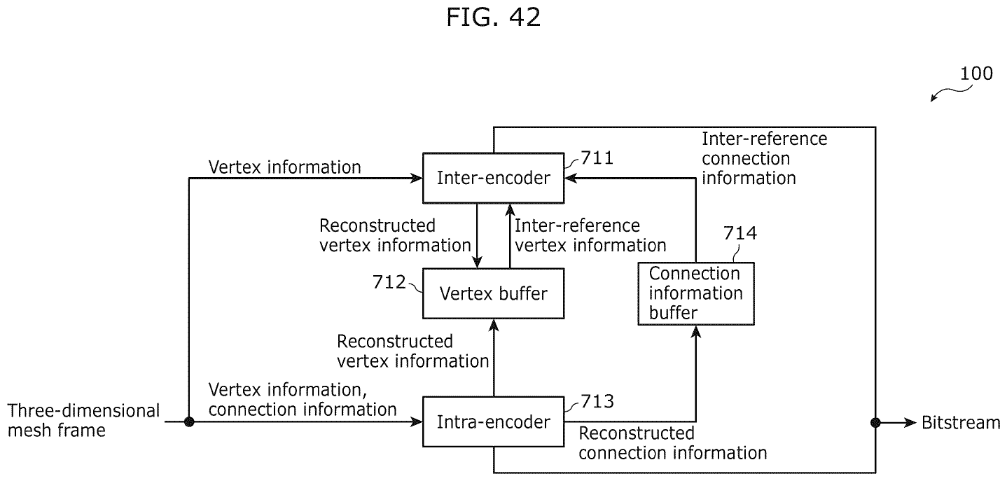

FIG. 42 is a block diagram illustrating a configuration example of encoding device 100 for switching between the intra-prediction and the inter-prediction on a vertex set basis according to the embodiment. In this example, encoding device 100 includes inter-encoder 711, vertex buffer 712, intra-encoder 713, and connection information buffer 714.

When a current vertex set to be processed is an inter-vertex set, inter-encoder 711 encodes a current vertex to be processed in the current vertex set by referring to an inter-reference vertex in vertex buffer 712. Here, the inter-vertex set is a vertex set formed by an inter-vertex that is processed by referring to a vertex in a processed frame.

For example, inter-encoder 711 generates an inter-predicted vertex using an inter-reference vertex. The inter-predicted vertex may be the inter-reference vertex itself. Inter-encoder 711 then encodes the difference between the inter-predicted vertex and the current vertex and adds the difference to the inter-predicted vertex, thereby reconstructing the current vertex.

The current vertex reconstructed by inter-encoder 711 is stored in vertex buffer 712 as a reconstructed vertex. The reconstructed vertex stored in vertex buffer 712 can be referred to, as an inter-reference vertex, in encoding of another vertex, for example.

Furthermore, inter-encoder 711 may encode the current vertex using connection information. Specifically, inter-encoder 711 may identify an inter-reference vertex using connection information. Furthermore, inter-encoder 711 may generate an inter-predicted vertex using an inter-reference vertex and connection information. Furthermore, connection information may be used to identify the current vertex or determine the encoding order.

Furthermore, inter-encoder 711 may encode the current vertex by referring to inter-reference connection information in connection information buffer 714. That is, inter-encoder 711 may encode the current vertex using connection information of a three-dimensional mesh in a reference frame. In this process, the connection information of the three-dimensional mesh in the reference frame may be used as connection information of a three-dimensional mesh in the current frame to be processed.

When the current vertex set to be processed is an intra-vertex set, intra-encoder 713 encodes a current vertex to be processed in the current vertex set by referring to an intra-reference vertex. Here, the intra-vertex set is a vertex set formed by an intra-vertex that is processed by referring to a vertex in the current frame.

For example, intra-encoder 713 generates an intra-predicted vertex using an intra-reference vertex. The intra-predicted vertex may be the intra-reference vertex itself. Intra-encoder 713 then encodes the difference between the intra-predicted vertex and the current vertex and adds the difference to the intra-predicted vertex, thereby reconstructing the current vertex.

Furthermore, intra-encoder 713 may encode the current vertex using connection information. Specifically, intra-encoder 713 may identify an intra-reference vertex using connection information. Furthermore, intra-encoder 713 may generate an intra-predicted vertex using an intra-reference vertex and connection information. Furthermore, connection information may be used to identify the current vertex or determine the encoding order.

Furthermore, intra-encoder 713 may encode the current vertex by referring to inter-reference connection information in connection information buffer 714. That is, intra-encoder 713 may encode the current vertex using connection information of a three-dimensional mesh in a reference frame. In this process, the connection information of the three-dimensional mesh in the reference frame may be used as connection information of a three-dimensional mesh in the current frame to be processed.

Furthermore, intra-encoder 713 encodes connection information of the current frame and reconstructs the connection information. The connection information reconstructed by intra-encoder 713 is stored in connection information buffer 714 as reconstructed connection information. The reconstructed connection information stored in connection information buffer 714 can be referred to, as an inter-reference connection information, in encoding of another vertex, for example.

Note that inter-encoder 711 and intra-encoder 713 may be able to encode the current vertex without referring to another vertex. That is, inter-encoder 711 and intra-encoder 713 may encode the current vertex itself, rather than the difference, in some cases. The operation in such a case corresponds to an operation of encoding the difference between a reference vertex and the current vertex on the assumption that the reference vertex is (0, 0, 0).

Encoding device 100 may further include a frame header encoder that encodes a frame header of each frame. The frame header may include reference information that indicates whether each vertex set included in the frame is an inter-vertex set or an intra-vertex set. Furthermore, encoding device 100 may determine, based on a temporal redundancy and a spatial redundancy, whether each vertex set is an inter-vertex set or an intra-vertex set.

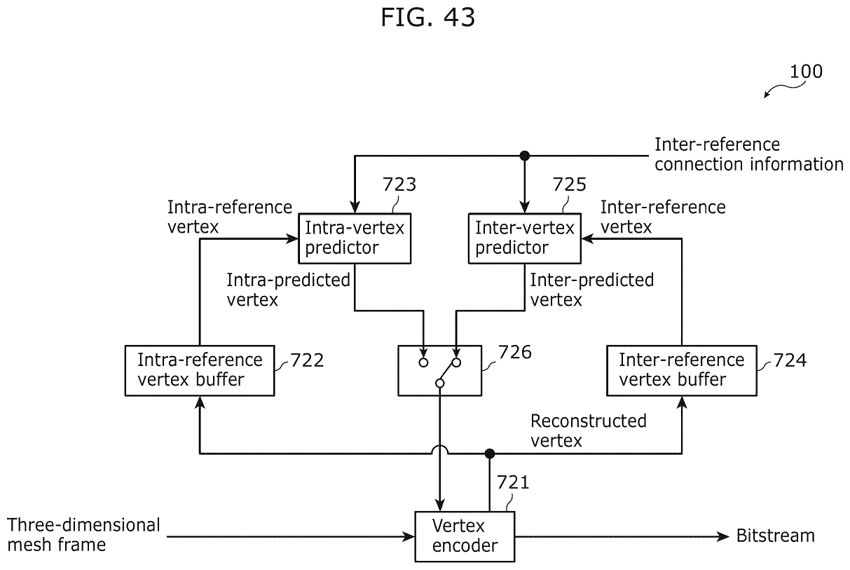

FIG. 43 is a block diagram illustrating another configuration example of encoding device 100 for switching between the intra-prediction and the inter-prediction on a vertex set basis according to the embodiment. In this example, encoding device 100 includes vertex encoder 721, intra-reference vertex buffer 722, intra-vertex predictor 723, inter-reference vertex buffer 724, inter-vertex predictor 725, and switch 726.

For example, among these components, inter-reference vertex buffer 724 corresponds to vertex buffer 712 in the example in FIG. 42, and a plurality of other components may correspond to inter-encoder 711.

Vertex encoder 721 acquires an intra-predicted vertex or an inter-predicted vertex as a predicted vertex via switch 726, and encodes a current vertex in a three-dimensional mesh frame into a bitstream using the predicted vertex. For example, vertex encoder 721 encodes the current vertex by encoding the difference between the predicted vertex and the current vertex. Furthermore, vertex encoder 721 generates a reconstructed vertex by adding the difference to the predicted vertex, and stores the reconstructed vertex in intra-reference vertex buffer 722 and inter-reference vertex buffer 724.

Intra-reference vertex buffer 722 stores the reconstructed vertex of the current frame. The reconstructed vertex stored in intra-reference vertex buffer 722 is referred to, as an intra-reference vertex. Inter-reference vertex buffer 724 stores not only the reconstructed vertex of the current frame but also a reconstructed vertex of a reference frame that is a frame encoded in the past. The reconstructed vertex stored in inter-reference vertex buffer 724 is referred to, as an inter-reference vertex.

Intra-vertex predictor 723 generates an intra-predicted vertex by referring to an intra-reference vertex in intra-reference vertex buffer 722. For example, intra-vertex predictor 723 may generate an intra-predicted vertex by selecting, as the intra-predicted vertex, any of one or more intra-reference vertexes in intra-reference vertex buffer 722. Intra-vertex predictor 723 may generate an intra-predicted vertex using inter-reference connection information that is connection information of a reference frame.

Inter-vertex predictor 725 generates an inter-predicted vertex by referring to an inter-reference vertex in inter-reference vertex buffer 724. For example, inter-vertex predictor 725 may generate an inter-predicted vertex by selecting, as the inter-predicted vertex, any of one or more intra-reference vertexes in inter-reference vertex buffer 724. Inter-vertex predictor 725 may generate an inter-predicted vertex using inter-reference connection information that is connection information of a reference frame.

Switch 726 supplies, as the predicted vertex, the intra-predicted vertex obtained by intra-vertex predictor 723 or the inter-predicted vertex obtained by inter-vertex predictor 725 to vertex encoder 721. For example, switch 726 may switch between the intra-predicted vertex and the inter-predicted vertex according to the reference information in units of a vertex set formed by one or more vertexes.

Encoding device 100 described above can encode a three-dimensional mesh frame including an intra-vertex set or an inter-vertex set into a bitstream.

### <Decoding Processing of Vertex Information>

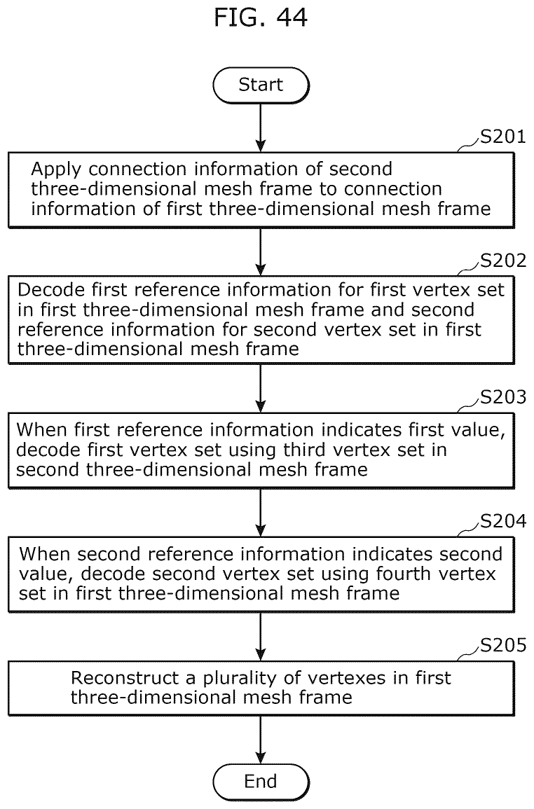

FIG. 44 is a flowchart illustrating mesh decoding processing according to the embodiment. In this example, first, connection information of a second three-dimensional mesh frame is applied to connection information of a first three-dimensional mesh frame (S201). Then, first reference information for a first vertex set in the first three-dimensional mesh frame and second reference information for a second vertex set in the first three-dimensional mesh frame are decoded from a bitstream (S202). An example of the first three-dimensional mesh frame is a current three-dimensional mesh frame to be decoded.

Each item of reference information may be represented by one or more reference parameters. An example of the reference parameter is an index of an identifier of the three-dimensional mesh frame. An example of the index is a numeric value, such as 0, 1, 2, and 3. Another example of the index is an alphabet, such as A, B, and C. Another example of the index is a Roman numeral, such as I, II, and III.

FIG. 35 is a conceptual diagram illustrating an example of the reference information according to the embodiment. In this example, the reference information is represented by a number that is an index of the identifier of the three-dimensional mesh frame. Specifically, the reference information is represented by “#3”. That is, in this example, the reference information indicates frame #3 among a plurality of frames #0 to #3. In another example, the reference information may indicate the current frame itself.

In the example in FIG. 44, when the first reference information indicates a first value, the first vertex set is decoded using a third vertex set in the second three-dimensional mesh frame (S203). Here, the second three-dimensional mesh frame is a three-dimensional mesh frame that is temporally different from the first three-dimensional mesh frame. An example of the second three-dimensional mesh frame is a three-dimensional mesh frame that is previously decoded.

An example of the third vertex set is all vertexes in a three-dimensional region. An example of the three-dimensional region is a rectangular parallelepiped defined by a height, a width, and a depth with respect to a reference point.

FIG. 36 is a conceptual diagram illustrating an example of the three-dimensional region according to the embodiment. In the example in FIG. 36, the three-dimensional region is a rectangular parallelepiped defined by a height of 3, a width of 2, and a depth of 3 with respect to a reference point (0, 2, 3). In another example, the three-dimensional area is a sphere defined by coordinates of the center and a radius. In another example, the three-dimensional region is a cube defined by coordinates of the vertexes and a length of the sides.

FIG. 37 is a conceptual diagram illustrating an example of a vertex set located inside a rectangular parallelepiped according to the embodiment. In this example, some of vertexes M, N, O, P, Q, and R of a three-dimensional mesh can be selected as a third vertex set because those vertexes are located inside a rectangular parallelepiped. For example, the third vertex set is formed by the vertexes in the upper rectangular parallelepiped, that is, the vertexes M, N, and O. In another example, the third vertex set is formed by the vertexes in the lower rectangular parallelepiped, that is, the vertexes P, Q, and R.

For example, the third vertex set is selected and used as a predicted vertex set for a first vertex set. An example of decoding of the first vertex set using the third vertex set is decoding the difference between the third vertex set and the first vertex set and adding the difference to the third vertex set to generate the first vertex set. Specifically, the differences between corresponding vertexes in the third vertex set and the first vertex set are decoded. Furthermore, in the decoding of a plurality of differences, a difference between differences may be decoded.

FIG. 38 is a conceptual diagram illustrating a relationship between the first vertex set, the third vertex set, and the difference therebetween according to the embodiment. Here, the third vertex set includes vertexes M (10, 8, 5), N (14, 3, 3), and O (12, 2, 2). For example, (2, 1, 3), (3, 1, 1), and (1, 0, 1) are decoded as differences. In this case, the differences are added to the third vertex set to reconstruct vertexes A (12, 9, 8), B (17, 4, 4), and C (13, 2, 3) as the first vertex set.

A difference between differences may be decoded. For example, as differences between differences, (2, 1, 3), (1, 0, −2), and (−2, 1, 0) are decoded. From the differences between differences, (2, 1, 3), (2, 1, 3)+ (1, 0, −2)=(3, 1, 1), and (3, 1, 1)+ (−2, 1, 0)=(1, 0, 1) may be derived as differences. From these differences, the vertexes A (12, 9, 8), B (17, 4, 4), and C (13, 2, 3) can be reconstructed as the first vertex set.

In the example in FIG. 44, when the second reference information indicates a second value, the second vertex set is decoded using a fourth vertex set in the first three-dimensional mesh frame (S204).

An example of the decoding of the second vertex set using the fourth vertex set is decoding the difference between the fourth vertex set and the second vertex set and adding the difference to the fourth vertex set to generate the second vertex set.

For example, the fourth vertex set includes one vertex. In decoding of the first vertex from the top in the second vertex set, the difference between the one vertex in the fourth vertex set and the first vertex from the top in the second vertex set is decoded. The difference is added to the one vertex in the fourth vertex set, thereby reconstructing the first vertex from the top in the second vertex set.

In decoding of the second vertex from the top in the second vertex set, the difference between the first vertex from the top in the second vertex set and the second vertex from the top in the second vertex set is decoded. The difference is added to the first vertex from the top in the second vertex set, thereby reconstructing the second vertex from the top in the second vertex set.

Furthermore, in decoding of the third vertex from the top in the second vertex set, the difference between the second vertex from the top in the second vertex set and the third vertex from the top in the second vertex set is decoded. The difference is added to the second vertex from the top in the second vertex set, thereby reconstructing the third vertex from the top in the second vertex set.

Such decoding of the difference may be repeated. Note that the order of decoding of vertexes may correspond to the order of scanning of vertexes.

FIG. 39 is a conceptual diagram illustrating a relationship between the second vertex set, the fourth vertex set, and the difference therebetween according to the embodiment. Here, the fourth vertex set includes a vertex C (13, 2, 3). As differences, (2, −1, −1), (4, −1, −2), and (−7, 1, 0) are decoded.

In this case, (2, −1, −1) is added to the vertex C (13, 2, 3) to reconstruct the vertex D (15, 1, 2). (4, −1, −2) is added to the vertex D (15, 1, 2) to reconstruct the vertex E (19, 0, 0). (−7, 1, 0) is added to the vertex E (19, 0, 0) to reconstruct the vertex F (12, 1, 0).

Note that the fourth vertex set may be regarded as partially overlapping with the second vertex set and including the vertexes C, D, and E. In that case, in decoding of the vertex D in the second vertex set, the difference between the vertexes C and D may be decoded. In decoding of the vertex E in the second vertex set, the difference between the vertexes D and E may be decoded. In decoding of the vertex F in the second vertex set, the difference between the vertexes E and F may be decoded.

Furthermore, the difference between the vertexes D and E corresponds to the difference between the difference between the vertexes C and D and the difference between the vertexes C and E. That is, the difference between the vertexes D and E can be regarded as a difference between differences.

In the example in FIG. 44, then, a plurality of vertexes in the first three-dimensional mesh frame are reconstructed (S205). The decoded first vertex set and the decoded second vertex set are included in the plurality of reconstructed vertexes in the first three-dimensional mesh frame.

FIG. 40 is a conceptual diagram illustrating an example in which a plurality of vertexes in the first three-dimensional mesh frame are reconstructed according to the embodiment. In this example, a plurality of vertexes in the first three-dimensional mesh frame are reconstructed by combining the first vertex set and the second vertex set. In another example of the reconstruction of the first vertex set and the second vertex set, the plurality of vertexes in the first vertex set and the second vertex set may form a base mesh, and some of these vertexes may be displaced using a displacement vector decoded from the bitstream.

In the example in FIG. 44, first, the connection information of the second three-dimensional mesh frame is applied to the connection information of the first three-dimensional mesh frame (S201). That is, the connection information of a three-dimensional mesh in the second three-dimensional mesh frame is applied to connection information of a plurality of vertexes reconstructed in the first three-dimensional mesh frame.

For example, when the first reference information indicates a first value, and at least one vertex of a triangle is included in the first vertex set, connection information of the triangle may be copied from the second three-dimensional mesh frame to the first three-dimensional mesh frame.

FIG. 41 is a conceptual diagram illustrating an example of the application of connection information according to the embodiment. Here, the vertexes A, B, and C are included in the first vertex set decoded using the third vertex set in the second three-dimensional mesh frame. Therefore, edges AB, BC, AC, CE, CF, BD, and BE are copied from the second three-dimensional mesh frame, and the vertexes A and B, B and C, A and C, C and E, C and F, B and D, and B and E are connected to each other. In addition, the vertexes D and E and the vertexes E and F may be treated as being connected to each other based on the decoding order.

In this example, connection information about the first vertex set decoded using the third vertex set in the second three-dimensional mesh frame is copied from the second three-dimensional mesh frame to the first three-dimensional mesh frame. That is, connection information about a vertex set to which the inter-prediction is applied is copied from the second three-dimensional mesh frame to the first three-dimensional mesh frame.

However, connection information may be copied from the second three-dimensional mesh frame to the first three-dimensional mesh frame, regardless of whether the connection information is connection information about a vertex set to which the inter-prediction is applied. Specifically, connection information about a vertex set to which the intra-prediction is applied may be copied from the second three-dimensional mesh frame to the first three-dimensional mesh frame.

Furthermore, in this example, connection information of the second three-dimensional mesh frame is applied to reconstructed vertex information of the first three-dimensional mesh frame. However, connection information of the second three-dimensional mesh frame may not only be applied to reconstructed vertex information of the first three-dimensional mesh frame but also be used as connection information of the first three-dimensional mesh frame.

Specifically, connection information of the second three-dimensional mesh frame may be used for decoding of a plurality of vertexes of the first three-dimensional mesh frame. More specifically, connection information of the second three-dimensional mesh frame may be used in the decoding order or prediction order of a plurality of vertexes in the first three-dimensional mesh frame, may be used for determination of a reference vertex or predicted vertex, or may be used for determination of whether the prediction is inter-prediction or intra-prediction.

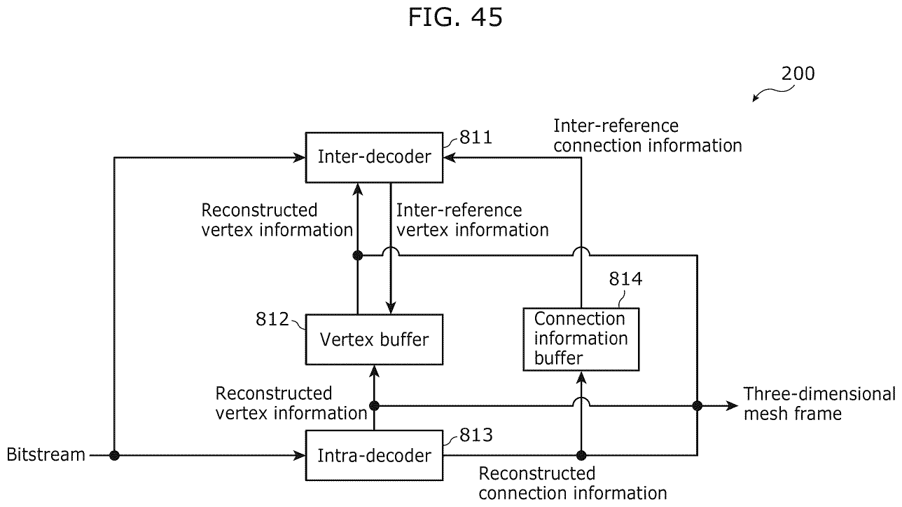

FIG. 45 is a block diagram illustrating a configuration example of decoding device 200 for switching between the intra-prediction and the inter-prediction on a vertex set basis according to the embodiment. In this example, decoding device 200 includes inter-decoder 811, vertex buffer 812, intra-decoder 813, and connection information buffer 814.

When a current vertex set to be processed is an inter-vertex set, inter-decoder 811 decodes a current vertex to be processed in the current vertex set by referring to an inter-reference vertex in vertex buffer 812. Here, the inter-vertex set is a vertex set formed by an inter-vertex that is processed by referring to a vertex in a processed frame.

For example, inter-decoder 811 generates an inter-predicted vertex using an inter-reference vertex. The inter-predicted vertex may be the inter-reference vertex itself. Inter-decoder 811 then decodes the difference between the inter-predicted vertex and the current vertex and adds the difference to the inter-predicted vertex, thereby reconstructing the current vertex.

The current vertex reconstructed by inter-decoder 811 is stored in vertex buffer 812 as a reconstructed vertex. The reconstructed vertex stored in vertex buffer 812 can be referred to, as an inter-reference vertex, in decoding of another vertex, for example.

Furthermore, inter-decoder 811 may decode the current vertex using connection information. Specifically, inter-decoder 811 may identify an inter-reference vertex using connection information. Furthermore, inter-decoder 811 may generate an inter-predicted vertex using an inter-reference vertex and connection information. Furthermore, connection information may be used to identify the current vertex or determine the decoding order.

Furthermore, inter-decoder 811 may decode the current vertex by referring to inter-reference connection information in connection information buffer 814. That is, inter-decoder 811 may decode the current vertex using connection information of a three-dimensional mesh in a reference frame. In this process, the connection information of the three-dimensional mesh in the reference frame may be used as connection information of a three-dimensional mesh in the current frame to be processed.

When the current vertex set to be processed is an intra-vertex set, intra-decoder 813 decodes a current vertex to be processed in the current vertex set by referring to an intra-reference vertex. Here, the intra-vertex set is a vertex set formed by an intra-vertex that is processed by referring to a vertex in the current frame.

For example, intra-decoder 813 generates an intra-predicted vertex using an intra-reference vertex. The intra-predicted vertex may be the intra-reference vertex itself. Intra-decoder 813 then decodes the difference between the intra-predicted vertex and the current vertex and adds the difference to the intra-predicted vertex, thereby reconstructing the current vertex.

Furthermore, intra-decoder 813 may decode the current vertex using connection information. Specifically, intra-decoder 813 may identify an intra-reference vertex using connection information. Furthermore, intra-decoder 813 may generate an intra-predicted vertex using an intra-reference vertex and connection information. Furthermore, connection information may be used to identify the current vertex or determine the decoding order.

Furthermore, intra-decoder 813 may decode the current vertex by referring to inter-reference connection information in connection information buffer 814. That is, intra-decoder 813 may decode the current vertex using connection information of a three-dimensional mesh in a reference frame. In this process, the connection information of the three-dimensional mesh in the reference frame may be used as connection information of a three-dimensional mesh in the current frame to be processed.

Intra-decoder 813 decodes connection information of the current frame and reconstructs the connection information. The connection information reconstructed by intra-decoder 813 is stored in connection information buffer 814 as reconstructed connection information. The reconstructed connection information stored in connection information buffer 814 can be referred to, as an inter-reference connection information, in decoding of another frame, for example.

Note that inter-decoder 811 and intra-decoder 813 may be able to decode the current vertex without referring to another vertex. That is, inter-decoder 811 and intra-decoder 813 may decode the current vertex itself, rather than the difference, in some cases. The operation in such a case corresponds to an operation of decoding the difference between a reference vertex and the current vertex on the assumption that the reference vertex is (0, 0, 0).

Decoding device 200 may further include a frame header decoder that decodes a frame header of each frame. The frame header may include reference information that indicates whether each vertex set included in the frame is an inter-vertex set or an intra-vertex set.

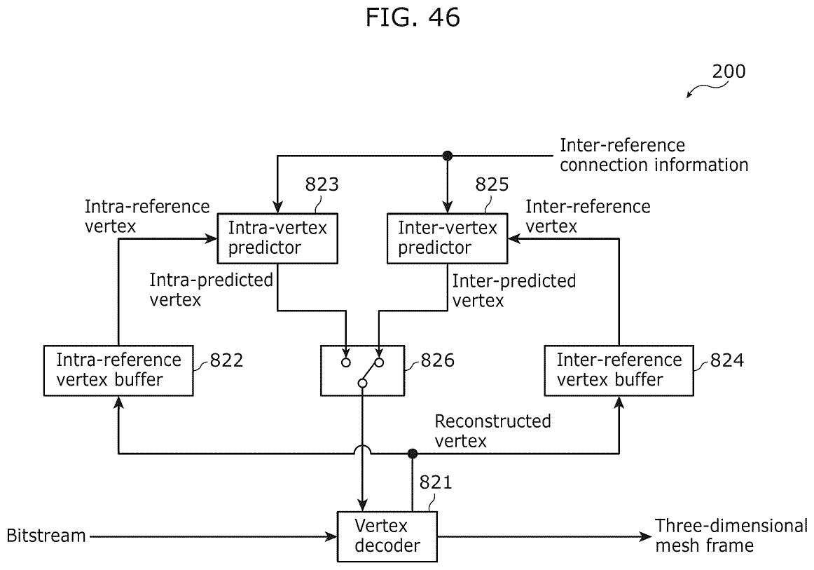

FIG. 46 is a block diagram illustrating another configuration example of decoding device 200 for switching between the intra-prediction and the inter-prediction on a vertex set basis according to the embodiment. In this example, decoding device 200 includes vertex decoder 821, intra-reference vertex buffer 822, intra-vertex predictor 823, inter-reference vertex buffer 824, inter-vertex predictor 825, and switch 826.

For example, among these components, inter-reference vertex buffer 824 corresponds to vertex buffer 812 in the example in FIG. 45, and a plurality of other components may correspond to inter-decoder 811.

Vertex decoder 821 acquires an intra-predicted vertex or an inter-predicted vertex as a predicted vertex via switch 826, and decodes a current vertex in a three-dimensional mesh frame from a bitstream using the predicted vertex. For example, vertex decoder 821 decodes the current vertex by decoding the difference between the predicted vertex and the current vertex. Furthermore, vertex decoder 821 generates a reconstructed vertex by adding the difference to the predicted vertex, and stores the reconstructed vertex in intra-reference vertex buffer 822 and inter-reference vertex buffer 824.

Intra-reference vertex buffer 822 stores the reconstructed vertex of the current frame. The reconstructed vertex stored in intra-reference vertex buffer 822 is referred to, as an intra-reference vertex. Inter-reference vertex buffer 824 stores not only the reconstructed vertex of the current frame but also a reconstructed vertex of a reference frame that is a frame decoded in the past. The reconstructed vertex stored in inter-reference vertex buffer 824 is referred to, as an inter-reference vertex.

Intra-vertex predictor 823 generates an intra-predicted vertex by referring to an intra-reference vertex in intra-reference vertex buffer 822. For example, intra-vertex predictor 823 may generate an intra-predicted vertex by selecting, as the intra-predicted vertex, any of one or more intra-reference vertexes in intra-reference vertex buffer 822. Intra-vertex predictor 823 may generate an intra-predicted vertex using inter-reference connection information that is connection information of a reference frame.

Inter-vertex predictor 825 generates an inter-predicted vertex by referring to an inter-reference vertex in inter-reference vertex buffer 824. For example, inter-vertex predictor 825 may generate an inter-predicted vertex by selecting, as the inter-predicted vertex, any of one or more intra-reference vertexes in inter-reference vertex buffer 824. Inter-vertex predictor 825 may generate an inter-predicted vertex using inter-reference connection information that is connection information of a reference frame.

Switch 826 supplies, as the predicted vertex, the intra-predicted vertex obtained by intra-vertex predictor 823 or the inter-predicted vertex obtained by inter-vertex predictor 825 to vertex decoder 821. For example, switch 826 may switch between the intra-predicted vertex and the inter-predicted vertex according to the reference information in units of a vertex set formed by one or more vertexes.

Decoding device 200 described above can decode a three-dimensional mesh frame including an intra-vertex set or an inter-vertex set from a bitstream.

<Supplements concerning Encoding and Decoding of Vertex Information>

The encoding processing and the decoding processing according to the embodiment can be applied to encoding of position information of a point in a point cloud compression scheme, such as V-PCC and G-PCC, for example.

In the embodiment, an example of the configuration for switching the reference vertex based on a parameter on a vertex set basis has been shown. For example, in prediction processing of coordinates of a plurality of vertexes to be encoded, one of the inter-prediction and the intra-prediction may be selected and applied on a vertex set basis. Here, the inter-prediction is prediction processing that uses coordinates of a vertex that belongs to a different frame than the vertex to be encoded and is already encoded. The intra-prediction is prediction processing that uses coordinates of a vertex that belongs to the same frame as the vertex to be encoded and is already encoded.

However, this example is not intended to be limiting, and one of prediction processing in which coordinates of a vertex that belongs to a different frame and is already encoded is referred to and other prediction processing in which coordinates of a vertex that belongs to a different frame and is already encoded may be selected and applied on a vertex set basis. Alternatively, one of prediction processing in which coordinates of a vertex that belongs to the same frame and is already encoded is referred to and other prediction processing in which coordinates of a vertex that belongs to the same frame and is already encoded may be selected and applied on a vertex set basis.

The number of vertexes forming a vertex set may be 1, 2, 3, or greater than 3. The number of vertexes forming a vertex set may be fixed or variable.

For example, a plurality of vertexes that form one or more continuous faces (such as a triangular or a rectangular face) may be treated as a set. Furthermore, the plurality of vertexes included in a set may belong to the same object. Furthermore, the plurality of vertexes included in a set may have a connectivity and be connected to each other. Furthermore, the vertexes included in a set may form the same mesh.

Furthermore, the prediction processing may be switched between the inter-prediction and the intra-prediction according to the prediction precision on a vertex basis. And one or more vertexes to which the inter-prediction is applied in succession or one or more vertexes to which the intra-prediction is applied in succession may form one set.

Note that in the present disclosure, a plurality of vertex sets may be included in one frame, and both a vertex set for the intra-encoding and a vertex set for the inter-encoding may exist in the same frame. Alternatively, a plurality of vertex sets for the intra-encoding or a plurality of vertex sets for the inter-encoding, but not both, may be included in one frame. Alternatively, only one vertex set for the intra-encoding or only one vertex set for the inter-encoding may be included in one frame.

Furthermore, in a vertex set for the inter-encoding, the encoding processing may be switched between the inter-encoding and the intra-encoding on a vertex basis.

Furthermore, the reference information may be encoded for each vertex set. The reference information may include information for switching between the inter-encoding and the intra-encoding. Specifically, the reference information may include identification information that indicates a frame to be referred to. Furthermore, the reference information may include a reference list that indicates a list of frames that can be referred to.

Furthermore, the reference information may include mode information that indicates whether the encoding processing is the inter-encoding and whether the encoding processing is intra-encoding. That is, the reference information may include mode information that indicates a mode to be applied among a plurality of modes that includes the inter-encoding and the intra-encoding. The mode information may indicate the mode to be applied in the form of a value.

Furthermore, the reference information may indicate a vertex set to be referred to. The reference information may indicate a region that includes a vertex set to be referred to. The reference information may indicate the number of vertexes forming a vertex set. The number of vertexes forming a vertex set may be fixed and encoded as other parameter information than the reference information that is encoded on a vertex set basis.

The reference information may be encoded in a header of a bitstream or may be encoded as part of vertex information. Furthermore, the reference information may be determined based on the spatial redundancy and the temporal redundancy or may be determined based on the encoding efficiency.

FIG. 47 is a conceptual diagram illustrating a first example of a method of specifying a vertex set for the inter-prediction. In this example, the reference information includes a reference frame index, the number of reference vertexes, and one or more reference vertex indexes.

Specifically, in this example, the reference information includes values “3, 2, 1, 2”. These values correspond to a reference frame index (#Frame), the number of reference vertexes (#number), and reference vertex indexes (#index1, #index2, #indexN, . . . ). The first value “3” indicates frame #3 previously decoded, the second value “2” indicates the number of reference vertexes, and the third value “1” and the fourth value “2” each indicate an index of a reference vertex. That is, the values “3, 2, 1, 2” as a whole indicate the vertexes A (6, 8, 9) and B (10, 6, 7) in frame #3 previously decoded, and these vertexes are used for reference.

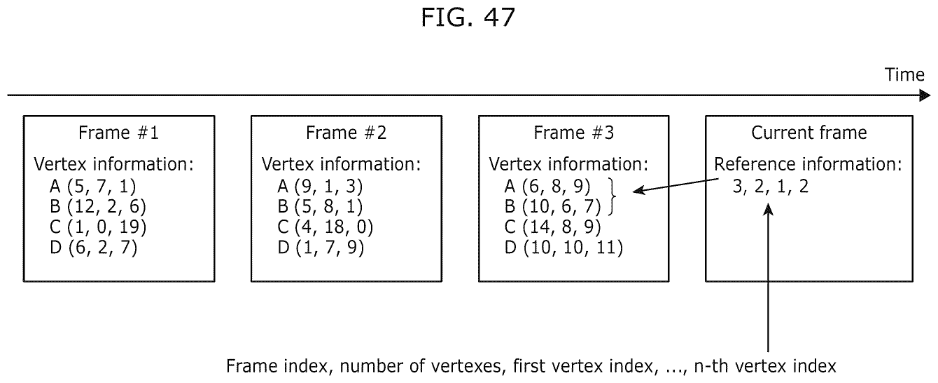

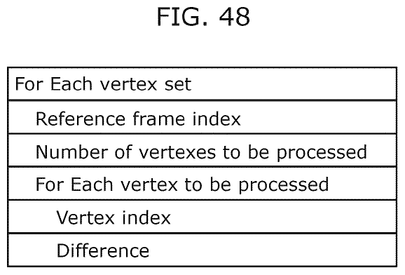

FIG. 48 is a syntax diagram illustrating a syntax structure that corresponds to the first example of the method of specifying a vertex set for the inter-prediction. For example, the reference information is signaled according to the syntax structure illustrated in FIG. 48.

FIG. 49 is a conceptual diagram illustrating a second example of the method of specifying a vertex set for the inter-prediction. In this example, the reference information includes a frame index, a start index, and an end index.

Specifically, in this example, the reference information includes values “3 (1, 3)”. These values correspond to a reference frame index (#Frame), an index of the first reference vertex (start index), and an index of the last reference vertex (end index).

The first value “3” indicates frame #3 previously decoded. The values “(1, 3)” indicate a start index and an end index for obtaining vertexes in the frame previously decoded. That is, the values “3 (1, 3)” as a whole indicate the vertexes A (6, 8, 9), B (10, 6, 7), and C (14, 8, 9) in frame #3 previously decoded. In this example, the start index and the end index are specified, and any indexes therebetween are not specified.

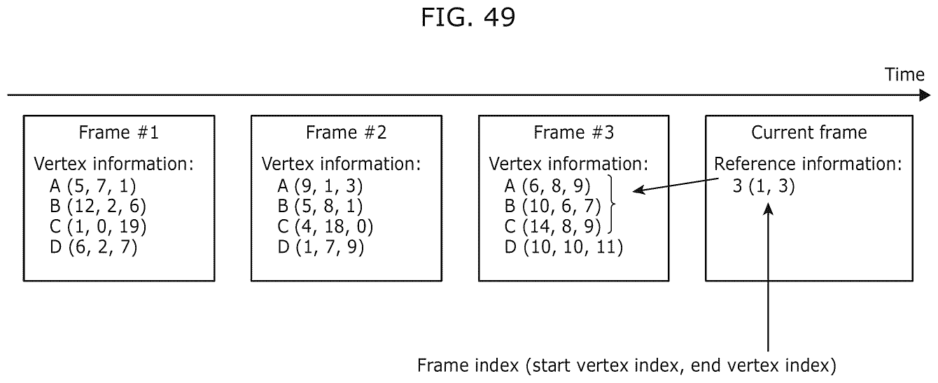

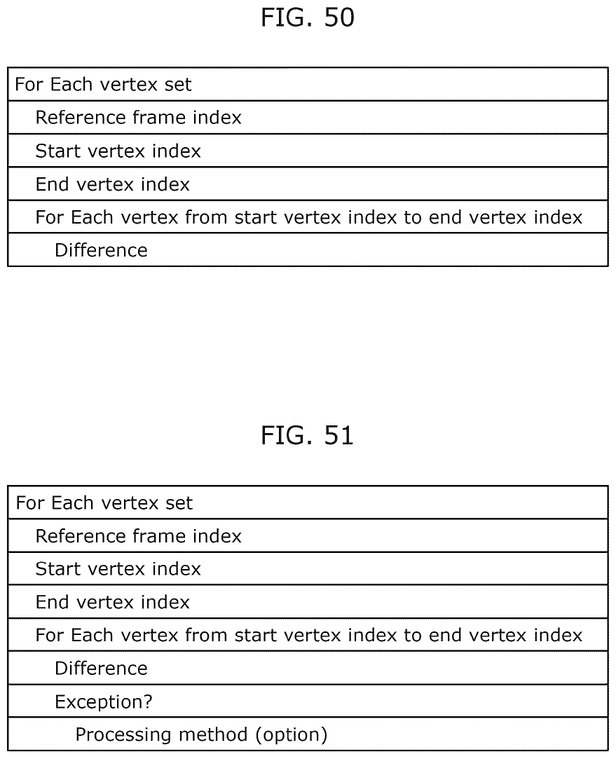

FIG. 50 is a syntax diagram illustrating a syntax structure that corresponds to the second example of the method of specifying a vertex set for the inter-prediction. For example, the reference information is signaled according to the syntax structure illustrated in FIG. 50.

FIG. 51 is a syntax diagram illustrating a variation of the syntax structure that corresponds to the second example of the method of specifying a vertex set for the inter-prediction. For example, the reference information is signaled according to the syntax structure illustrated in FIG. 51. Specifically, between the start index and the end index, a vertex that is not included in the reference vertex set may be specified as an exception. The vertex specified as an exception need not be used as a reference vertex.

FIG. 52 is a conceptual diagram illustrating a third example of the method of specifying a vertex set for the inter-prediction. In this example, the reference information includes a frame index, a reference position (x, y, z), and a reference size (height, width, depth).

Specifically, in this example, the reference information includes values “3, (5, 4, 7), (5, 4, 2)”. These values are used to specify a vertex within a height of 5, a width of 4, and a depth of 2 with respect to a reference position (5, 4, 7) in frame #3 previously decoded. Here, the reference position, the height, the width, and the depth define a reference region having the shape of a rectangular parallelepiped.

In this example, a vertex in a rectangular parallelepiped in the reference frame is selected. In reference frame #3, there are two vertexes A and B within the height of 5, the width of 4 and the depth of 2 with respect to the reference position (5, 4, 7). Therefore, these two vertexes (A (6, 8, 9) and B (10, 6, 7)) are used as reference vertexes.

In another example, the reference position may be derived using a vertex previously decoded and need not be signaled in the bitstream. In another example, the height, the width, and the depth may be determined in advance or signaled in the header.

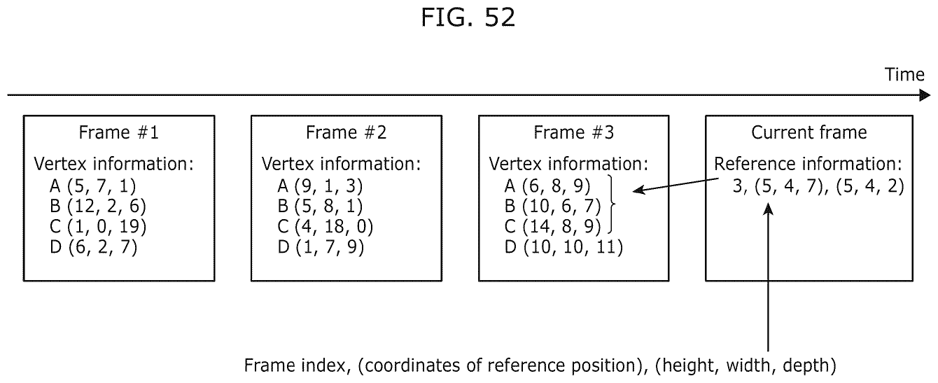

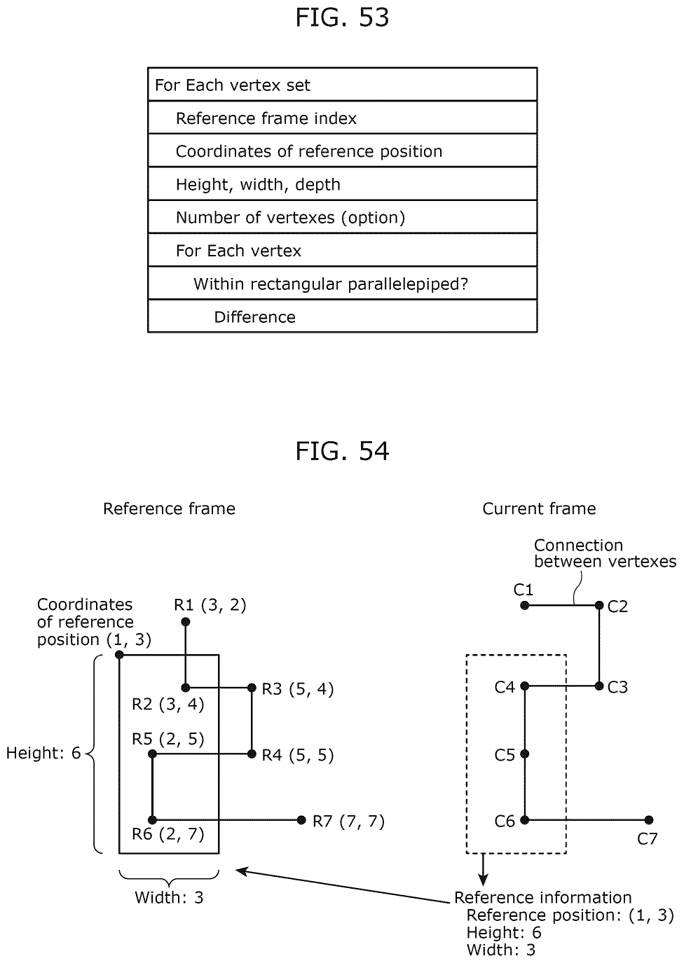

FIG. 53 is a syntax diagram illustrating a syntax structure that corresponds to the third example of the method of specifying a vertex set for the inter-prediction. For example, the reference information is signaled according to the syntax structure illustrated in FIG. 53.

FIG. 54 is a conceptual diagram two-dimensionally illustrating a vertex set specified in the third example of the method of specifying a vertex set for the inter-prediction. That is, FIG. 54 illustrates a vertex set that is two-dimensionally selected (on the assumption that there is no depth information) in the specifying method illustrated in FIG. 52. In this example, vertexes C1, C2, and C3 are decoded. Vertex C4 is then decoded. Decoding device 200 decodes the reference information from the bitstream.

For example, the reference information indicates a reference position (1, 3), a height of 6, and a width of 3, and indicates a region having the shape of a rectangle in the two-dimensional space (a rectangular parallelepiped in the three-dimensional space). Vertexes R2, R5, and R6 are located within a rectangle having a height of 6 and a width of 3 with respect to the reference position (1, 3). Since there are three vertexes R2, R5, and R6 in the rectangle, three vertexes C4, C5, and C6 in the current frame are then decoded using reference vertexes R2, R5, and R6, respectively.

FIG. 55 is a conceptual diagram illustrating a fourth example of the method of specifying a vertex set for the inter-prediction. In this example, the reference information includes a frame index, a reference position (x, y, z), and a radius.

Specifically, in this example, the reference information includes values “3, (6, 4, 5), 4”. These values are used to specify a vertex within a radius of 4 with respect to a reference position (6, 4, 5) in frame #3 previously decoded. The reference position and the radius define a reference region having the shape of a sphere.

In this example, a vertex in a sphere in the reference frame is selected. In reference frame #3, there are two vertexes A (6, 8, 9) and B (10, 6, 7) within the radius of 4 with respect to the reference position (6, 4, 5). Therefore, these two vertexes A (6, 8, 9) and B (10, 6, 7) are used as reference vertexes.

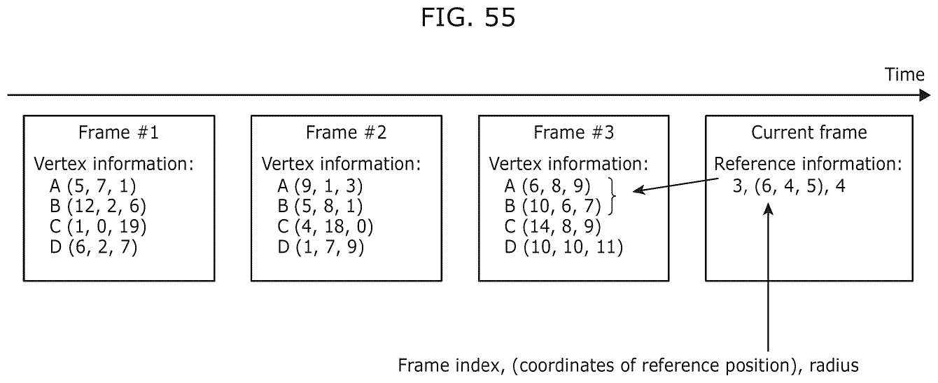

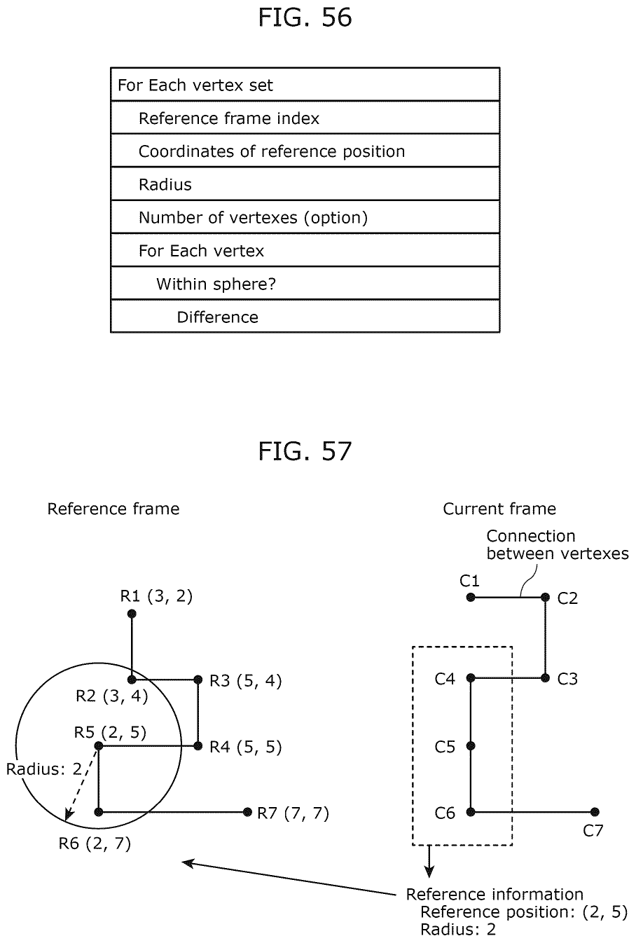

FIG. 56 is a syntax diagram illustrating a syntax structure that corresponds to the fourth example of the method of specifying a vertex set for the inter-prediction. For example, the reference information is signaled according to the syntax structure illustrated in FIG. 56.

FIG. 57 is a conceptual diagram two-dimensionally illustrating a vertex set specified in the fourth example of the method of specifying a vertex set for the inter-prediction. That is, FIG. 57 illustrates a vertex set that is two-dimensionally selected (on the assumption that there is no depth information) in the specifying method illustrated in FIG. 55. In this example, vertexes C1, C2, and C3 are decoded. Vertex C4 is then decoded. Decoding device 200 decodes the reference information from the bitstream.

For example, the reference information indicates a reference position (2, 5), a radius of 2, and indicates a region having the shape of a circle in the two-dimensional space (a sphere in the three-dimensional space). Vertexes R2, R5, and R6 are located within a circle having a radius of 2 with respect to the reference position (2, 5). Since there are three vertexes R2, R5, and R6 in the circle, three vertexes C4, C5, and C6 in the current frame are then decoded using reference vertexes R2, R5, and R6, respectively.

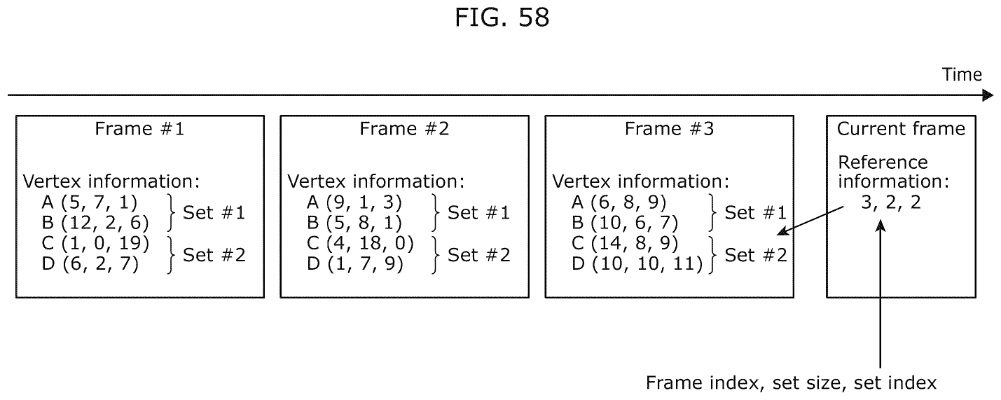

FIG. 58 is a conceptual diagram illustrating a fifth example of the method of specifying a vertex set for the inter-prediction. In this example, the reference information includes a frame index, the size of each vertex set, and an index of a vertex set to be referred to.

Specifically, in this example, the reference information includes values “3, 2, 2”. These values are used to specify a vertex in vertex set #2 in frame #3 previously decoded. In this example, there are two vertexes C (14, 8, 9) and D (10, 10, 11) in vertex set #2 in reference frame #3. Therefore, these two vertexes C (14, 8, 9) and B (10, 10, 11) are used as reference vertexes.

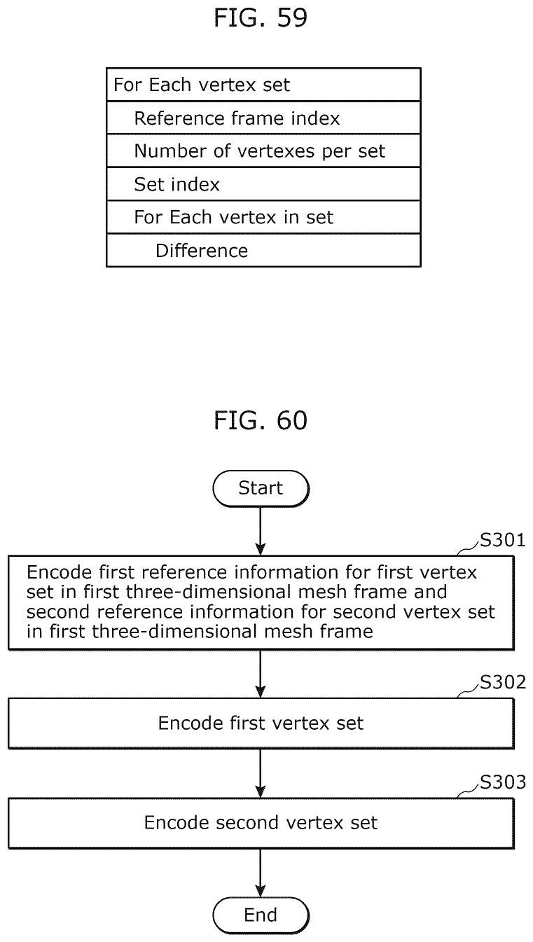

FIG. 59 is a syntax diagram illustrating a syntax structure that corresponds to the fifth example of the method of specifying a vertex set for the inter-prediction. For example, the reference information is signaled according to the syntax structure illustrated in FIG. 59.

### Representative Example

FIG. 60 is a flow chart illustrating an example of basic encoding processing according to the present embodiment. For example, circuit 151 of encoding device 100 illustrated in FIG. 24 performs the encoding processing illustrated in FIG. 60 in an operation.

Specifically, circuit 151 encodes, into a bitstream, first reference information for a first set of vertices in a first three-dimensional mesh frame and second reference information for a second set of vertices in the first three-dimensional mesh frame (S301). In addition, circuit 151 encodes the first set of vertices into the bitstream (S302). Circuit 151 also encodes the second set of vertices into the bitstream (S303).

Here, the first reference information indicates a first value when a third set of vertices in a second three-dimensional mesh frame is used for the encoding of the first set of vertices. The second three-dimensional mesh frame is temporally different from the first three-dimensional mesh frame. The second reference information indicates a second value when a fourth set of vertices in the first three-dimensional mesh frame is used for the encoding of the second set of vertices.

Accordingly, in encoding of the first vertex set and the second vertex set in the same three-dimensional mesh frame, it may be possible to apply the inter-prediction to the first vertex set and apply the intra-prediction to the second vertex set. Therefore, the code amount may be able to be reduced.

For example, when the third set of vertices is used for the encoding of the first set of vertices, circuit 151 may encode the first set of vertices using connection information of a three-dimensional mesh in the second three-dimensional mesh frame. Accordingly, the connection information may be able to be reused in the inter-prediction. Therefore, encoding of the connection information may be able to be omitted in the inter-prediction. Therefore, the code amount of the connection information may be able to be omitted in the inter-prediction.

Moreover, for example, regardless of whether the third set of vertices is used for the encoding of the first set of vertices, circuit 151 may encode the first set of vertices using connection information of a three-dimensional mesh in the second three-dimensional mesh frame. Moreover, regardless of whether the fourth set of vertices is used for the encoding of the second set of vertices, circuit 151 may encode the second set of vertices using connection information of a three-dimensional mesh in the second three-dimensional mesh frame.

Accordingly, regardless of whether in the inter-prediction or the intra-prediction, the connection information may be able to be reused. Therefore, regardless of whether in the inter-prediction or the intra-prediction, encoding of the connection information may be able to be omitted. Therefore, regardless of whether in the inter-prediction or the intra-prediction, the code amount of the connection information may be able to be omitted.

Moreover, for example, each reference information item may indicate a value for identifying a three-dimensional mesh frame to be referred to. Accordingly, the three-dimensional mesh frame to be referred to may be able to be efficiently specified. Note that the first value may be a value for identifying the second three-dimensional mesh frame, and the second value may be a value for identifying the first three-dimensional mesh frame.

Moreover, for example, each reference information item may indicate, as a value, whether the second three-dimensional mesh frame is to be referred to. Accordingly, whether the inter-prediction is used or not may be able to be efficiently specified. Note that the first value may be a value representing that the second three-dimensional mesh frame is to be referred to.

Moreover, for example, each reference information item may indicate, as a value, whether the first three-dimensional mesh frame is to be referred to. Accordingly, whether the intra-prediction is used or not may be able to be efficiently specified. Note that the second value may be a value representing that the first three-dimensional mesh frame is to be referred to.

Moreover, for example, the first three-dimensional mesh frame may be a three-dimensional mesh frame to be encoded. Accordingly, each vertex set in the three-dimensional mesh frame to be encoded may be able to be efficiently encoded.

Moreover, for example, the second three-dimensional mesh frame may be an encoded three-dimensional mesh frame. Accordingly, when the inter-prediction is used for encoding of the first vertex set, the first vertex set may be able to be efficiently encoded using the encoded three-dimensional mesh frame.

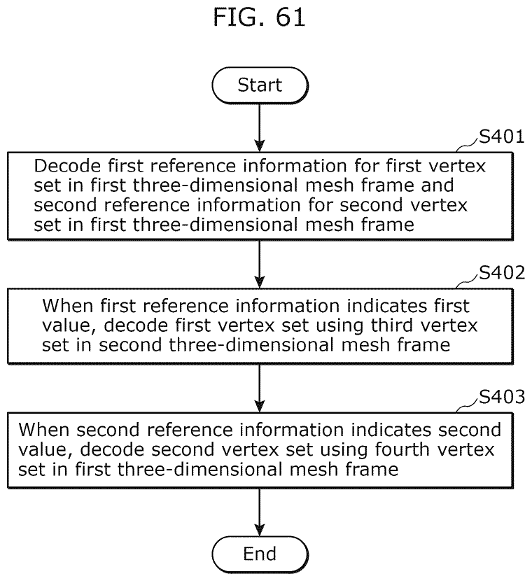

FIG. 61 is a flow chart illustrating an example of basic decoding processing according to the present embodiment. For example, circuit 251 of decoding device 200 illustrated in FIG. 25 performs the decoding processing illustrated in FIG. 61 in an operation.

Specifically, circuit 251 decodes, from a bitstream, first reference information for a first set of vertices in a first three-dimensional mesh frame and second reference information for a second set of vertices in the first three-dimensional mesh frame (S401).

Subsequently, circuit 251 decodes the first set of vertices from the bitstream using a third set of vertices in a second three-dimensional mesh frame when the first reference information indicates a first value (S402). The second three-dimensional mesh frame is temporally different from the first three-dimensional mesh frame. Circuit 251 also decodes the second set of vertices from the bitstream using a fourth set of vertices in the first three-dimensional mesh frame when the second reference information indicates a second value (S403).

Accordingly, in decoding of the first vertex set and the second vertex set in the same three-dimensional mesh frame, it may be possible to apply the inter-prediction to the first vertex set and apply the intra-prediction to the second vertex set. Therefore, the code amount may be able to be reduced.

For example, when the first reference information indicates the first value, circuit 251 may decode the first set of vertices using connection information of a three-dimensional mesh in the second three-dimensional mesh frame. Accordingly, the connection information may be able to be reused in the inter-prediction. Therefore, decoding of the connection information may be able to be omitted in the inter-prediction. Therefore, the code amount of the connection information may be able to be omitted in the inter-prediction.

Moreover, regardless of whether the first reference information indicates the first value or indicates the second value, circuit 251 may decode the first set of vertices using connection information of a three-dimensional mesh in the second three-dimensional mesh frame. Regardless of whether the second reference information indicates the first value or indicates the second value, circuit 251 may decode the second set of vertices using connection information of a three-dimensional mesh in the second three-dimensional mesh frame.

Accordingly, regardless of whether in the inter-prediction or the intra-prediction, the connection information may be able to reused. Therefore, regardless of whether in the inter-prediction or the intra-prediction, decoding of the connection information may be able to be omitted. Therefore, regardless of whether in the inter-prediction or the intra-prediction, the code amount of the connection information may be able to be omitted.

Moreover, for example, each reference information item may indicate a value for identifying a three-dimensional mesh frame to be referred to. Accordingly, the three-dimensional mesh frame to be referred to may be able to be efficiently specified. Note that the first value may be a value for identifying the second three-dimensional mesh frame, and the second value may be a value for identifying the first three-dimensional mesh frame.

Moreover, for example, each reference information item indicates, as a value, whether the second three-dimensional mesh frame is to be referred to. Accordingly, whether the inter-prediction is used or not may be able to be efficiently specified. Note that the first value may be a value representing that the second three-dimensional mesh frame is to be referred to.

Moreover, for example, each reference information item indicates, as a value, whether the first three-dimensional mesh frame is to be referred to. Accordingly, whether the intra-prediction is used or not may be able to be efficiently specified. Note that the second value may be a value representing that the first three-dimensional mesh frame is to be referred to.

Moreover, for example, the first three-dimensional mesh frame may be a three-dimensional mesh frame to be decoded. Accordingly, each vertex set in the three-dimensional mesh frame to be decoded may be able to be efficiently decoded.

Moreover, for example, the second three-dimensional mesh frame may be a decoded three-dimensional mesh frame. Accordingly, when the inter-prediction is used for decoding of the first vertex set, the first vertex set may be able to be efficiently decoded using the decoded three-dimensional mesh frame.

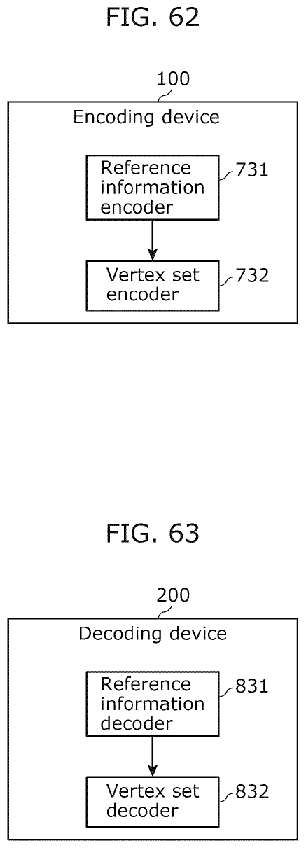

FIG. 62 is a block diagram illustrating yet another configuration example of encoding device 100 according to the present embodiment. In this example, encoding device 100 includes reference information encoder 731 and vertex set encoder 732.

Reference information encoder 731 is, for example, an electric circuit. Reference information encoder 731 may correspond to preprocessor 104, postprocessor 105, and the like described above and may be implemented by circuit 151 and memory 152 described above.

Vertex set encoder 732 is, for example, an electric circuit. Vertex set encoder 732 may correspond to vertex information encoder 101, inter-encoder 711, intra-encoder 713, vertex encoder 721, and the like described above and may be implemented by circuit 151 and memory 152 described above.

For example, reference information encoder 731 encodes, into a bitstream, first reference information for a first set of vertices in a first three-dimensional mesh frame and second reference information for a second set of vertices in the first three-dimensional mesh frame.

Subsequently, vertex set encoder 732 encodes the first set of vertices into the bitstream using a third set of vertices in a second three-dimensional mesh frame when the first reference information indicates a first value. The second three-dimensional mesh frame is temporally different from the first three-dimensional mesh frame. Vertex set encoder 732 also encodes the second set of vertices into the bitstream using a fourth set of vertices in the first three-dimensional mesh frame when the second reference information indicates a second value.

Accordingly, in encoding of the first vertex set and the second vertex set in the same three-dimensional mesh frame, it may be possible to apply the inter-prediction to the first vertex set and apply the intra-prediction to the second vertex set. Therefore, the code amount may be able to be reduced. Note that encoding device 100 may include another encoder that encodes the other information.

FIG. 63 is a block diagram illustrating yet another configuration example of decoding device 200 according to the present embodiment. In this example, decoding device 200 includes reference information decoder 831 and vertex set decoder 832.

Reference information decoder 831 is, for example, an electric circuit. Reference information decoder 831 may correspond to preprocessor 204, postprocessor 205, and the like described above and may be implemented by circuit 251 and memory 252 described above.

Vertex set decoder 832 is, for example, an electric circuit. Vertex set decoder 832 may correspond to vertex information decoder 201, inter-decoder 811, intra-decoder 813, vertex decoder 821, and the like described above and may be implemented by circuit 251 and memory 252 described above.

For example, reference information decoder 831 decodes, from a bitstream, first reference information for a first set of vertices in a first three-dimensional mesh frame and second reference information for a second set of vertices in the first three-dimensional mesh frame.

Subsequently, vertex set decoder 832 decodes the first set of vertices from the bitstream using a third set of vertices in a second three-dimensional mesh frame when the first reference information indicates a first value. The second three-dimensional mesh frame is temporally different from the first three-dimensional mesh frame. Vertex set decoder 832 also decodes the second set of vertices from the bitstream using a fourth set of vertices in the first three-dimensional mesh frame when the second reference information indicates a second value.

Accordingly, in decoding of the first vertex set and the second vertex set in the same three-dimensional mesh frame, it may be possible to apply the inter-prediction to the first vertex set and apply the intra-prediction to the second vertex set. Therefore, the code amount may be able to be reduced. Note that decoding device 200 may include another decoder that decodes the other information.

### OTHER EXAMPLES

Although the aspects of encoding device 100 and decoding device 200 have thus far been described according to the embodiment, the aspects of encoding device 100 and decoding device 200 are not limited to the embodiment. Modifications that may be conceived by a person skilled in the art may be applied to the embodiment, and a plurality of constituent elements in the embodiment may be combined in any manner.

For example, processing performed by a specific constituent element in the embodiment may be performed by a different constituent element instead of the specific constituent element. Moreover, the order of processes may be changed or processes may be performed in parallel.

In the above description, the second three-dimensional mesh frame represents any three-dimensional mesh frame other than the first three-dimensional mesh frame and need not necessarily represent a particular three-dimensional mesh frame.

The “vertex set” in the present disclosure corresponds to a plurality of vertexes in units of encoding of a displacement vector, for example. The “vertex set” may have other names. For example, the vertex set” may be referred to as a “vertex group”. Alternatively, the “vertex set” may be referred to as a “displacement vector group”, a “vector group”, or a “motion group”, since the vertex set is associated with a plurality of displacement vectors that correspond to a plurality of vertexes. Other names can also be used. The “vertex set” in the present disclosure can be interchanged with any of these names.

Furthermore, the “vertex set” in the present disclosure may be a set of a plurality of items of divisional data obtained by dividing arbitrary data other than a displacement vector that corresponds to a plurality of vertexes when encoding or decoding the data.

Furthermore, different terms may be used, depending on whether referring to vertexes or data: a unit of division of a plurality of vertexes forming a mesh may be referred to as a “vertex set” or a “vertex group”, and a unit of division of data of a plurality of vertexes forming a mesh may be referred to as a “data set” or a “data group”. In that case, the “vertex set” in the present disclosure can be interchanged with any of these terms, depending on the object indicated by the term.

Note that the number of vertexes forming a “vertex set” in the present disclosure or the number of items of data that correspond to the vertexes may be fixed or variable within an arbitrary unit of encoding, such as a mesh or a frame. In addition, the number of vertexes forming a “vertex set” or the number of items of data that correspond to the vertexes may be derived based on another unit of encoding, such as a sub-mesh.

Moreover, as stated above, it is possible to implement, as an integrated circuit, at least part of the plurality of constituent elements in the present disclosure. At least part of the processes in the present disclosure may be used as an encoding method or a decoding method. A program for causing a computer to execute the encoding method or the decoding method may be used. Furthermore, a non-transitory computer-readable recording medium on which the program is recorded may be used. In addition, a bitstream for causing decoding device 200 to perform decoding may be used.

Moreover, at least part of the plurality of constituent elements and the processes in the present disclosure may be used as a transmitting device, a receiving device, a transmitting method, and a receiving method. A program for causing a computer to execute the transmitting method or the receiving method may be used. Furthermore, a non-transitory computer-readable recording medium on which the program is recorded may be used.

### INDUSTRIAL APPLICABILITY

The present disclosure is useful in, for example, an encoding device, a decoding device, a transmitting device, a receiving device, and the like related to a three-dimensional mesh and can be applied to a computer graphics system, a three-dimensional data display system, and the like.

1. An encoding method comprising:
encoding, into a bitstream, first reference information for a first set of vertices in a first three-dimensional mesh frame and second reference information for a second set of vertices in the first three-dimensional mesh frame;
encoding the first set of vertices into the bitstream; and
encoding the second set of vertices into the bitstream, wherein
the first reference information indicates a first value when a third set of vertices in a second three-dimensional mesh frame is used for the encoding of the first set of vertices, the second three-dimensional mesh frame being temporally different from the first three-dimensional mesh frame, and
the second reference information indicates a second value when a fourth set of vertices in the first three-dimensional mesh frame is used for the encoding of the second set of vertices.

2. The encoding method according to claim 1, wherein
when the third set of vertices is used for the encoding of the first set of vertices, the first set of vertices is encoded using connection information of a three-dimensional mesh in the second three-dimensional mesh frame.

3. The encoding method according to claim 1, wherein
regardless of (i) whether the third set of vertices is used for the encoding of the first set of vertices and (ii) whether the fourth set of vertices is used for the encoding of the second set of vertices, the first set of vertices and the second set of vertices are encoded using connection information of a three-dimensional mesh in the second three-dimensional mesh frame.

4. The encoding method according to claim 1, wherein
each of the first reference information and the second reference information indicates a value for identifying a three-dimensional mesh frame to be referred to.

5. The encoding method according to claim 1, wherein
each of the first reference information and the second reference information indicates, as a value, whether the second three-dimensional mesh frame is to be referred to.

6. The encoding method according to claim 1, wherein
each of the first reference information and the second reference information indicates, as a value, whether the first three-dimensional mesh frame is to be referred to.

7. The encoding method according to claim 1, wherein
the first three-dimensional mesh frame is a three-dimensional mesh frame to be encoded.

8. The encoding method according to claim 1, wherein
the second three-dimensional mesh frame is an encoded three-dimensional mesh frame.

9. A decoding method comprising:
decoding, from a bitstream, first reference information for a first set of vertices in a first three-dimensional mesh frame and second reference information for a second set of vertices in the first three-dimensional mesh frame;
decoding the first set of vertices from the bitstream using a third set of vertices in a second three-dimensional mesh frame when the first reference information indicates a first value, the second three-dimensional mesh frame being temporally different from the first three-dimensional mesh frame; and
decoding the second set of vertices from the bitstream using a fourth set of vertices in the first three-dimensional mesh frame when the second reference information indicates a second value.

10. The decoding method according to claim 9, wherein
when the first reference information indicates the first value, the first set of vertices is decoded using connection information of a three-dimensional mesh in the second three-dimensional mesh frame.

11. The decoding method according to claim 9, wherein
regardless of (i) whether the first reference information indicates the first value or indicates the second value and (ii) whether the second reference information indicates the first value or indicates the second value, the first set of vertices and the second set of vertices are decoded using connection information of a three-dimensional mesh in the second three-dimensional mesh frame.

12. The decoding method according to claim 9, wherein
each of the first reference information and the second reference information indicates a value for identifying a three-dimensional mesh frame to be referred to.

13. The decoding method according to claim 9, wherein
each of the first reference information and the second reference information indicates, as a value, whether the second three-dimensional mesh frame is to be referred to.

14. The decoding method according to claim 9, wherein
each of the first reference information and the second reference information indicates, as a value, whether the first three-dimensional mesh frame is to be referred to.

15. The decoding method according to claim 9, wherein
the first three-dimensional mesh frame is a three-dimensional mesh frame to be decoded.

16. The decoding method according to claim 9, wherein
the second three-dimensional mesh frame is a decoded three-dimensional mesh frame.

17. An encoding device comprising:
memory; and
a circuit accessible to the memory, wherein
in operation, the circuit:
encodes, into a bitstream, first reference information for a first set of vertices in a first three-dimensional mesh frame and second reference information for a second set of vertices in the first three-dimensional mesh frame;
encodes the first set of vertices into the bitstream; and
encodes the second set of vertices into the bitstream,
the first reference information indicates a first value when a third set of vertices in a second three-dimensional mesh frame is used for the encoding of the first set of vertices, the second three-dimensional mesh frame being temporally different from the first three-dimensional mesh frame, and
the second reference information indicates a second value when a fourth set of vertices in the first three-dimensional mesh frame is used for the encoding of the second set of vertices.

18. A decoding device comprising:
memory; and
a circuit accessible to the memory, wherein
in operation, the circuit:
decodes, from a bitstream, first reference information for a first set of vertices in a first three-dimensional mesh frame and second reference information for a second set of vertices in the first three-dimensional mesh frame;
decodes the first set of vertices from the bitstream using a third set of vertices in a second three-dimensional mesh frame when the first reference information indicates a first value, the second three-dimensional mesh frame being temporally different from the first three-dimensional mesh frame; and
decodes the second set of vertices from the bitstream using a fourth set of vertices in the first three-dimensional mesh frame when the second reference information indicates a second value.
